(19) United States
(12) Patent Application Publication
(10) Pub. No.: US 2022/0373902 A1
(43) Pub. Date: Nov. 24, 2022

(54) METHOD FOR PRODUCING ELECTROSTATIC IMAGE DEVELOPING TONER AND ELECTROSTATIC IMAGE DEVELOPING TONER

(71) Applicant: FUJIFILM BUSINESS INNOVATION CORP., Tokyo (JP)

(72) Inventors: Yosuke AKABANE, Kanagawa (JP); Takahiro YAMASHITA, Kanagawa (JP); Kazuhiko NAKAMURA, Kanagawa (JP); Yuji ISSHIKI, Kanagawa (JP)

(73) Assignee: FUJIFILM BUSINESS INNOVATION CORP., Tokyo (JP)

(21) Appl. No.: 17/459,600

(22) Filed: Aug. 27, 2021

(30) Foreign Application Priority Data
May 21, 2021 (JP) 2021-086314

(51) Int. Cl. G03G 9/08; G03G 9/087; B01F 15/06; B01F 7/00

(52) U.S. Cl. CPC G03G 9/081; G03G 9/0823; G03G 9/08711; G03G 9/0804; G03G 9/0819; B01F 15/065; B01F 7/00316; B01F 2215/0059; B01F 2215/0431

(57) ABSTRACT

A method for producing an electrostatic image developing toner includes mixing toner particles containing an amorphous resin with additive particles. A mixing device used in the mixing includes a stirring vessel, a stirring blade, and a jacket configured to cool the stirring vessel, and condition (1) and condition (2) are satisfied. Condition (1): an internal temperature Ti of the mixing device in the mixing and a glass transition temperature Tg of the amorphous resin contained in a near-surface portion of the toner particles satisfy Tg−50° C.≤Ti<Tg (inequality 1). Condition (2): 0.08≤ (Pm−P0)/w≤0.50 (inequality 2) is satisfied. In inequality 2, Pm represents an average power (kW) of a motor for driving the stirring blade of the mixing device in the mixing, P0 represents an idling power (kW) of the motor, and w represents a total mass (kg) of the toner particles and the additive particles in the mixing device.

### CROSS-REFERENCE TO RELATED APPLICATIONS

This application is based on and claims priority under 35 USC 119 from Japanese Patent Application No. 2021-086314 filed May 21, 2021.

### BACKGROUND

### (i) Technical Field

The present disclosure relates to a method for producing an electrostatic image developing toner and an electrostatic image developing toner.

### (ii) Related Art

Methods for visualizing image information, such as electrophotography, are currently used in various fields. In electrophotography, charging and electrostatic image formation are performed to form an electrostatic image as image information on the surface of an image carrier. A developer containing a toner is then used to form a toner image on the surface of the image carrier. This toner image is transferred to a recording medium and is then fixed to the recording medium. These steps visualize the image information as an image.

For example, Japanese Unexamined Patent Application Publication No, 2010-224159 discloses a method for producing an electrophotographic toner. The method includes (a) mixing a powder containing 100 parts by weight of colored base particles containing a binder resin and a colorant and 4.0 to 7.0 parts by weight of large-particle-size silica having a volume-median particle size of 30 to 100 nm by using a mixing device having a mixing blade such that the tip peripheral speed of the mixing blade is in the range of 40 to 80 m/s and the amount of applied power energy per unit weight of the powder is in the range of 0.01 to 0.05 kwh/kg, thereby (b) bringing the temperature of the powder to a temperature higher than the glass transition temperature (Tg) of the colored base particles.

### SUMMARY

Aspects of non limiting embodiments of the present disclosure relate to a method for producing an electrostatic image developing toner. The method includes mixing toner particles containing an amorphous resin with additive particles. A mixing device used in the mixing includes a stirring blade and a stirring vessel equipped with a jacket and has a temperature control mechanism configured to pass cooling water through the jacket. The method provides high transferability and high image unevenness suppressibility, as compared to when an internal temperature Ti of the mixing device in the mixing is lower than Tg−50° C. or Tg or higher, where Tg is a glass transition temperature of the amorphous resin contained in a near-surface portion of the toner particles satisfy, or when inequality 2 or inequality 3 given below is not satisfied.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a method for producing an electrostatic image developing toner, the method including mixing toner particles containing an amorphous resin with additive particles. A mixing device used in the mixing includes a stirring vessel, a stirring blade, and a jacket configured to cool the stirring vessel, and condition (1) and condition (2) are satisfied: Condition (1): an internal temperature Ti of the mixing device in the mixing and a glass transition temperature Tg of the amorphous resin contained in a near-surface portion of the toner particles satisfy Tg−50° C.≤Ti<Tg (inequality 1); and Condition (2): 0.08≤(Pm−P0)/w≤0.50 (inequality 2) is satisfied. In inequality 2, Pm represents an average power (kW) of a motor of the mixing device in the mixing, P0 represents an idling power (kW) of the motor, and w represents a total mass (kg) of the toner particles and the additive particles in the mixing device.

### BRIEF DESCRIPTION OF THE DRAWINGS

Exemplary embodiments of the present disclosure will be described in detail based on the following figures, wherein:

FIG. 1 schematically illustrates an example of a mixing device suitable for use in a method for producing an electrostatic image developing toner according to an exemplary embodiment;

FIG. 2 schematically illustrates an example of a stirring blade of the mixing device used in the method for producing an electrostatic image developing toner according to the exemplary embodiment;

FIG. 3 schematically illustrates another example of a stirring blade of the mixing device used in the method for producing an electrostatic image developing toner according to the exemplary embodiment;

FIG. 4 schematically illustrates another example of a stirring blade of the mixing device used in the method for producing an electrostatic image developing toner according to the exemplary embodiment;

FIG. 5 schematically illustrates another example of a stirring blade of the mixing device used in the method for producing an electrostatic image developing toner according to the exemplary embodiment;

FIG. 6 schematically illustrates another example of a stirring blade of the mixing device used in the method for producing an electrostatic image developing toner according to the exemplary embodiment;

FIG. 7 schematically illustrates another example of a stirring blade of the mixing device used in the method for producing an electrostatic image developing toner according to the exemplary embodiment;

FIG. 8 schematically illustrates another example of a stirring blade of the mixing device used in the method for producing an electrostatic image developing toner according to the exemplary embodiment;

FIG. 9 schematically illustrates another example of a stirring blade of the mixing device used in the method for producing an electrostatic image developing toner according to the exemplary embodiment;

FIG. 10 illustrates a schematic configuration of an example of an image forming apparatus according so an exemplary embodiment;

FIG. 11 illustrates a schematic configuration of an example of a process cartridge according to an exemplary embodiment; and

FIG. 12 illustrates a schematic configuration of an example of an additive feeding device suitable for use in an exemplary embodiment.

### DETAILED DESCRIPTION

Exemplary embodiments of the present disclosure will be described below in detail.

In numerical ranges described in stages, the upper limit value or the lower limit value described in one numerical range may be replaced with the upper limit value or the lower limit value of other numerical ranges described in stages.

In a numerical range, the upper limit value or the lower limit value described in the numerical range may be replaced with a value described in Examples.

If there are two or more substances corresponding to one component in a composition, the amount of the component in the composition refers to the total amount of the two or more substances present in the composition, unless otherwise specified.

The term “step” encompasses not only a separate step but also a step that is not clearly distinguished from another step if the desired object of the step is achieved.

### Method for Producing Electrostatic Image Developing Toner

A method for producing an electrostatic image developing toner according to a first exemplary embodiment includes a mixing step of mixing toner particles containing an amorphous resin with add five particles. In this method, a mixing device used in the mixing step includes a stirring vessel, a stirring blade, and a jacket configured to cool the stirring vessel, and condition (1) and condition (2) are satisfied.

Condition (1): an internal temperature Ti of the mixing device in the mixing step and a glass transition temperature Tg of the amorphous resin contained in a near-surface portion of the toner particles satisfy Tg−50° C.≤Ti<Tg (inequality 1).

Condition (2): 0.08≤(Pm−P0)/w≤0.50 (inequality 2) is satisfied.

In inequality 2, Pm represents an average power (kw) of a motor for driving the stirring blade of the mixing device in the mixing step, P0 represents an idling power (kW) of the motor, and w represents a total mass (kg) of the toner particles and the additive particles in the mixing device.

A method for producing an electrostatic image developing toner according to a second exemplary embodiment includes mixing step of mixing toner particles containing an amorphous resin with additive particles. In this method, a mixing device used in the mixing step includes a stirring blade and a stirring vessel equipped with a jacket, and condition (1) and condition (3) are satisfied.

Condition (1): an internal temperature Ti of the mixing device in the mixing step and a glass transition temperature Tg of the amorphous resin contained in a near-surface portion of the toner particles satisfy Tg−50° C.≤Ti<Tg (inequality 1).

Condition (3): 40≤(Pm−P0)·t/w≤300 (inequality 3) is satisfied.

In inequality 3, t represents a mixing time (s) in the mixing step, Pm represents an average power (kW) of a motor for driving the stirring blade of the mixing device in the mixing step, P0 represents an idling power (kW) of the motor, and w represents a total mass (kg) of the toner particles and the additive particles in the mixing device.

In this specification, the phrase “the method for producing an electrostatic image developing toner according to the exemplary embodiment” refers to both the method according to the first exemplary embodiment and the method according to the second exemplary embodiment, unless otherwise specified. The term, for example, “mixing device” refers to all the mixing devices in the first exemplary embodiment and the second exemplary embodiment, unless otherwise specified.

In the exemplary embodiment, the near-surface portion of the toner particles refers to a portion extending from the toner particle surface to a depth of 200 nm.

The electrostatic image developing toner according to the exemplary embodiment is a toner produced by the method for producing an electrostatic image developing toner according to the exemplary embodiment.

In recent years, image formation by electrophotography has been required to achieve both high image quality and high reliability. As a means to simultaneously achieve high image quality and high reliability, a toner having a small particle size and a narrow particle size distribution produced by a wet process has been developed. However, when toner particles obtained by a wet process are used alone, various properties such as transferability, charging characteristics, and flowability of the toner cannot satisfy the requirements for a developer. To improve these properties, mixing of inorganic oxide particles or the like as external additives has been previously conducted. The state of adhesion of such external additive particles to the surface of toner particles has a great influence not only on the charging characteristics of the toner particles but also on image quality. For example, when the adhesion of the external additive particles to the toner particles is too weak (free components exist in large amounts), relatively high powder flowability is provided, but the external additive particles adhere to a carrier to worsen the charge amount and charge amount distribution of the toner, thus leading to uneven development. In contrast, when the adhesion to the toner particles is too strong, the flowability of the toner particles is reduced to decrease transfer efficiency, and the external additives are buried in the toner to widen the charge amount distribution. Therefore, the state of adhesion of the external additive particles to the toner particle surface is optimized in the process for producing the toner.

As a method for achieving good adhesion of external additive particles to a toner particle surface, mixing at a temperature higher than the glass transition temperature of the toner has been proposed (see, for example, Japanese Unexamined Patent Application Publication No. 2010-224159). However, when mixing is performed at a temperature higher than the glass transition temperature of the toner, external additive particles with relatively low adhesive strength having an average particle size of 60 nm or more are provided with moderate adhesiveness, but the state of adhesion of additive particles with relatively high adhesive strength having an average particle size of less than 60 nm becomes excessive, and the external additive is buried in the toner to widen the charge amount distribution, thus causing image unevenness.

It is presumed that in the method for producing an electrostatic image developing toner according to the exemplary embodiment, condition (1) and condition above or condition (1) and condition (3) above are satisfied, whereby the temperature in the mixing device and the power or workload are adjusted, as a result of which the adhesive strength (uniform dispersibility) of the additive particles is controlled to be in a good range, thus providing an electrostatic image developing toner having high transferability and high image unevenness suppressibility.

When the additive particles include large-size additive particles and small-size additive particles, image unevenness is more likely to occur, but also in this case, the method for producing an electrostatic image developing toner according to the exemplary embodiment provides an electrostatic image developing toner having high transferability and high image unevenness suppressibility.

The steps will each be described below in detail.

### Mixing Step

The method for producing an electrostatic image developing toner according to the first exemplary embodiment includes a mixing step of mixing toner particles containing an amorphous resin (also referred to simply as “toner particles”) with additive particles. In this method, a mixing device used in the mixing step includes a stirring blade and a stirring vessel equipped with a jacket and has a temperature control mechanism configured to bass cooling water through the jacket, and condition (1) and condition (2) above are satisfied.

The method for producing an electrostatic image developing toner according to the second exemplary embodiment includes a mixing step of mixing toner particles containing an amorphous resin with additive particles. In this method, a mixing device used in the mixing step includes a stirring vessel, a stirring blade, and a jacket. configured to cool the stirring vessel, and condition (1) and condition (3) above are satisfied.

### Condition (1)

The method for producing an electrostatic image developing toner according to the exemplary embodiment satisfies condition (1) below.

Condition (1): an internal temperature Ti of the mixing device in the mixing step and a glass transition temperature Tg of the amorphous resin contained in a near-surface portion of the toner particles satisfy Tg−50° C.≤Ti<Tg (inequality 1).

In the method for producing an electrostatic image developing toner according to the exemplary embodiment, from the viewpoint of transferability and image unevenness suppressibility, Ti is preferably “Tg−40° C.” or higher and “Tg−5° C.” or lower, more preferably “Tg−30° C.” or higher and “Tg−10° C.” or lower.

The internal temperature Ti of the mixing device in the mixing step may be an internal temperature of the stirring vessel.

When the amorphous resin contained in a near-surface portion of the toner particles includes two or more amorphous resins, Tg is the glass transition temperature of an amorphous resin dominantly present in the near-surface portion.

### Condition (2)

The method for producing an electrostatic image developing toner according to the first exemplary embodiment satisfies condition (2) below.

Condition (2): 0.08≤(Pm−P0)/w≤0.50 (inequality 2) is satisfied.

In inequality 2, Pm represents an average power (kW) of a motor for driving the stirring blade of the mixing device in the mixing step, P0 represents an idling power (kW) of the motor, and w represents a total mass (kg) of the toner particles and the additive particles in the mixing device.

The method for producing an electrostatic image developing toner according to the second exemplary embodiment may satisfy condition (2) above from the viewpoint of transferability and image unevenness suppressibility.

From the viewpoint of transferability and image unevenness suppressibility, the method for producing an electrostatic image developing toner according to the exemplary embodiment more preferably satisfies inequality (2-1) below, particularly preferably satisfies inequality (2-2) below.

0.10≤(Pm−P0)/w≤0.40 (inequality 2-1)

0.15≤(Pm−P0)/w≤0.35 (inequality 2-2)

### Condition (3)

The method for producing an electrostatic image developing toner according to the second exemplary embodiment satisfies condition (3).

Condition (3): 40≤(Pm−P0)·t/w≤300 (inequality 3) is satisfied.

In inequality 3, t represents a sizing time (s) in the mixing step, Pm represents an average power (kW) of a motor for driving the stirring blade of the mixing device in the mixing step, P0 represents an idling power (kW) of the motor, and w represents a total mass (kg) of the toner particles and the additive particles in the mixing device.

The method for producing an electrostatic image developing toner according to the first exemplary embodiment may satisfy condition (3) above from the viewpoint of transferability and image unevenness suppressibility.

From the viewpoint of transferability and image unevenness suppressibility, the method for producing an electrostatic image developing toner according to the exemplary embodiment more preferably satisfies inequality (3-1) below, particularly preferably satisfies inequality (3-2) below.

60≤(Pm−P0)·t/w≤240 (inequality 3-1)

100≤(Pm−P0)·t/w≤200 (inequality 3-2)

The mixing device used in the mixing step includes a stirring blade and a stirring vessel equipped with a jacket and has a temperature control mechanism configured to pass cooling water through the jacket.

The mixing device may be any known mixing device as long as it is a device including a stirring vessel, a stirring blade, and jacket configured to cool the stirring vessel.

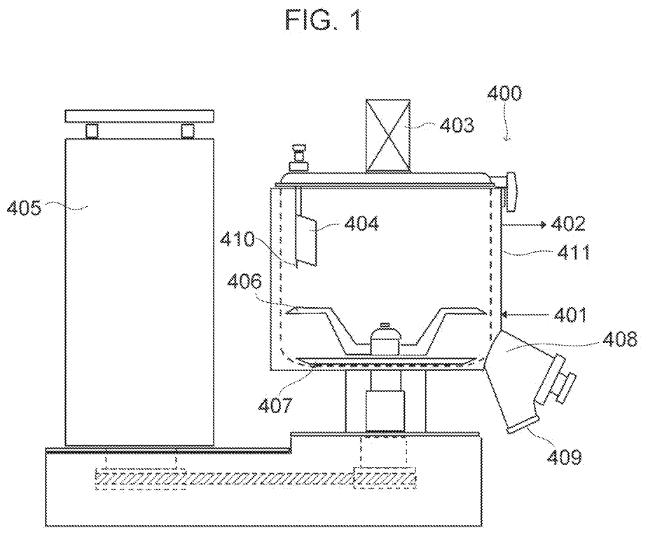

One suitable example of the mixing device is a mixing device illustrated in FIG. 1.

A mixing device 400 illustrated in FIG. 1 includes a stirring vessel 411, a stirring blade constituted by an upper blade 406 and a lower blade 407, and a jacket (not. illustrated) configured to cool the stirring vessel. 411.

Toner particles and additive particles, which are raw material powders, are loaded from above the stirring vessel 411 and hatch processed. The stirring vessel 411 is opened through an air filter 403 so that the pressure in the stirring vessel 411 is always atmospheric pressure.

The stirring blade constituted by the upper blade 406 and the lower blade 407 is rotated by the power from a motor 405.

A processing object flows upward as the lower blade 407 rotates, and is powerfully sheared by the upper blade 406. Under the centrifugal force resulting from these rotational motions, the processing object moves toward the inner wall of the stirring vessel 411. This moving processing object is pushed back toward the center of the stirring vessel 411 by a deflector 404 whose angle is adjustable. This series of actions generates a circulating flow to provide a highly homogeneous mixture.

The inside of the stirring vessel 411 is cooled by passing cooling water, such as 5° C. cold water, through the jacket (not illustrated). The cooling water enters through a cooling water inlet 401 and exits through a cooling water outlet 402. The internal temperature of the stirring vessel 411 can be measured using a temperature sensor 410 such as a thermocouple or a resistance thermometer. Not only cooling water but also warm water or the like may be passed through the jacket. Furthermore, the jacket may have a temperature control mechanism that operates in conjunction with the temperature sensor 410. The temperature control using the temperature control mechanism may be performed by manual operation or automatic operation.

The shape and material of the stirring vessel used in the exemplary embodiment are not particularly limited, and any known stirring vessel may be used. From the viewpoint of the cooling efficiency of the jacket, a metal stirring vessel may be used.

The shape and material of the stirring blade used in the exemplary embodiment are not particularly limited, and any known stirring blade may be used.

In particular, the stirring blade may be, for example, a stirring blade constituted by a combination of an upper blade and a lower blade from the viewpoint of transferability and image unevenness suppressibility.

The shape and material of the upper blade and the lower blade are not particularly limited, and any known upper blade and lower blade may be used in an appropriate combination depending on the intended use.

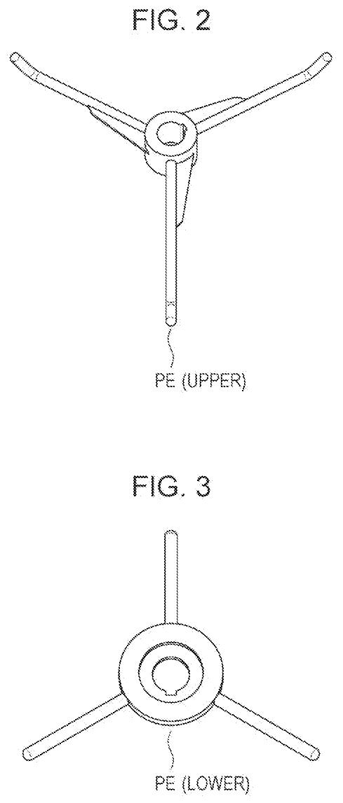

For example, the upper blade and the lower blade are suitably blades having shapes illustrated in FIG. 2 to FIG. 9.

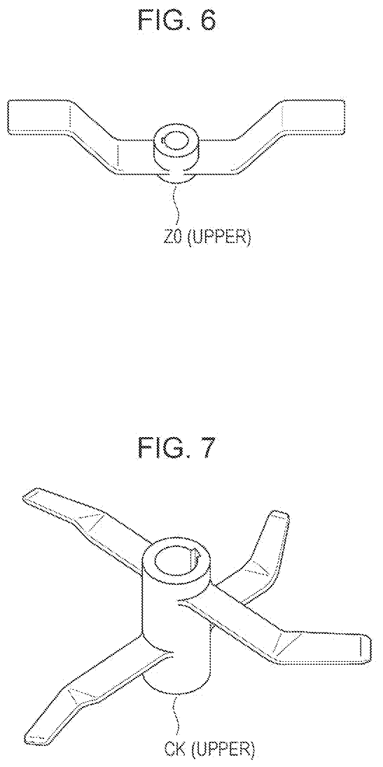

For example, the upper blade is more suitably a blade having a shape illustrated in FIG. 2 or any of FIG. 6 to FIG. 9, and the lower blade is more suitably a blade having a shape illustrated in any of FIG. 3 to FIG. 5.

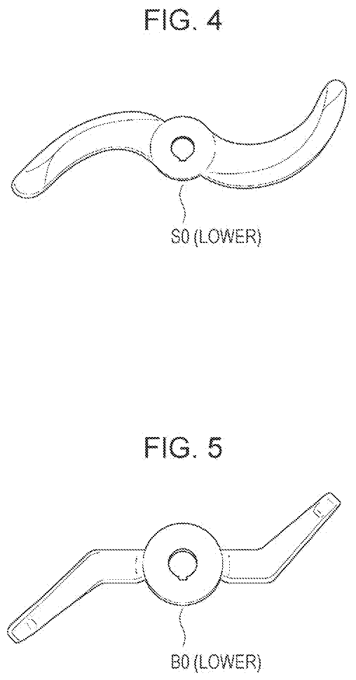

A lower blade S0 (lower) illustrated in FIG. 4 is a lower blade having a very strong power to stir up.

An upper blade Z0 (upper) illustrated in FIG. 6 makes a strong motion and is suitable for processing of relatively large amounts and processing such as kneading of highly viscous slurry-like or rice-cake-like materials.

An upper blade CK (upper) illustrated in FIG. 7 acts to press a processing object against the inner wall of the stirring vessel and has high mass-processing power because of a double blade located at a high position.

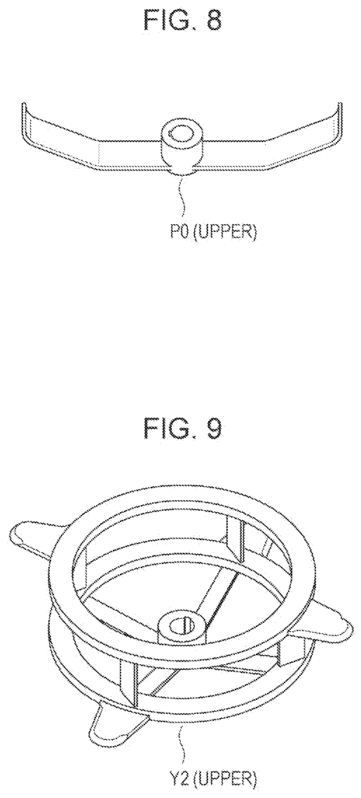

An upper blade P0 (upper) illustrated in FIG. 8 is a blade that easily arrange the particle size at a low speed because the blade is bent up at a portion where its peripheral speed is fastest.

An upper blade Y2 (upper) illustrated in FIG. 9, which is provided with fins between a first stage and a second stage, causes no up-down pulsations due to the effect of a ring-shaped blade and provides well-balanced stirring.

Of these, a stirring blade constituted by a combination of the upper blade Z0 (upper) illustrated in FIG. 6 and a lower blade B0 (lower) illustrated in FIG. 5 is particularly preferred because the free ratios of both large-size additive particles and small-size additive particles are easily controlled.

The rotation speed of the stirring blade in the mixing step is not particularly limited, and from the viewpoint of transferability and image unevenness suppressibility, it is preferably 5 m/s or more and 100 m/s or less, more preferably 10 m/s or more and 90 m/s or less, particularly preferably 20 m/s or more and 80 m/s or less.

The cooling in the stirring vessel is performed by passing cooling water such as 5° C. cold water through the jacket.

The temperature control in the stirring vessel may be performed, for example, in the following manner: passing of water through the jacket is stopped at the start of the batch in the mixing step; the temperature in the stirring vessel is kept monitored with a thermocouple, a resistance thermometer, or the like, and passing of water through the jacket is started at the timing when the temperature in the vessel increasing due to heat of mixing from the start of mixing has exceeded the temperature set under prescribed conditions; and the passing of water is stopped at the timing when the batch is completed or when the temperature falls below the temperature set under the prescribed conditions. The temperature control in the stirring vessel may be performed based on the prescribed conditions set depending on the type of additives by a process control computer upstream of the control.

The use of the above temperature controlling method allows the final temperature of each batch to be controlled to be within a certain range, thus stabilizing the temperature profile in the vessel in a continuous batch process. Each batch in the mixing step is prescribed based on the mixing time. The temperature of oil for shaft cooling is controlled to be constant by using cooling water, whereby stable equipment mixing is performed.

The control of the passing of cooling water through the jacket may be performed, for example, with an automatic valve disposed in an installed pipe connected to the cooling water inlet. The passing of water through the jacket is initiated by opening the automatic valve and stopped by closing the automatic valve. The control may be achieved in such a manner that the automatic controller in the mixing step monitors the temperature in the stirring vessel with a thermocouple, a resistance thermometer, or the like and opens the automatic valve disposed in the installed pipe at a temperature set under prescribed conditions.

Alternatively, the automatic valve may be operated at any timing with the automatic controller switched to the manual mode.

From the viewpoint of transferability and image unevenness suppressibility, the set internal temperature of the mixing device at which cooling is started by passing water through the jacket in the mixing step is preferably “the glass transition temperature Tg of the amorphous resin−30° C.” or higher and “the glass transition temperature Tg of the amorphous resin−5° C.” or lower, more preferably “the glass transition temperature Tg of the amorphous resin−20° C.” or higher and “the glass transition temperature Tg of the amorphous resin−5° C.” or lower.

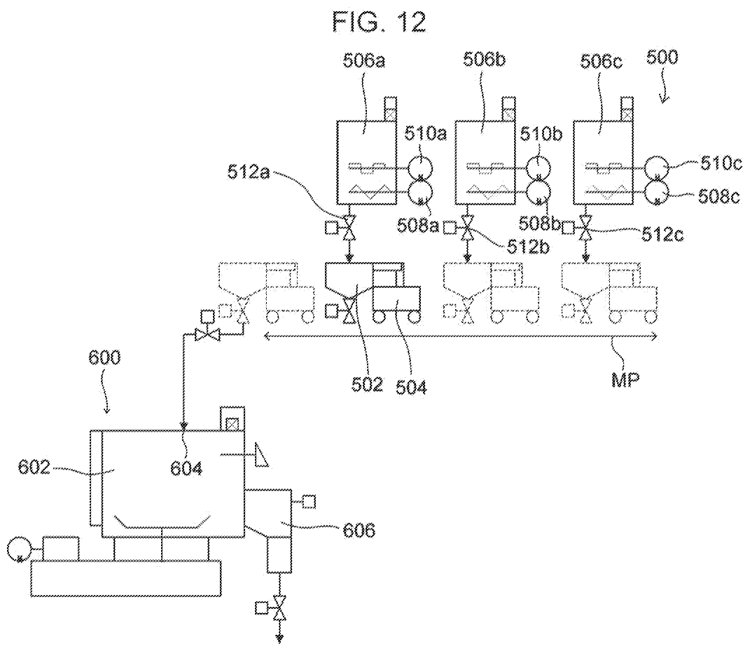

In the mixing step, an additive feeding device may be used in order to efficiently perform weighing of a plurality of types of additive particles and feeding of the plurality of types of additive particles to the stirring device. The additive feeding device may be, for example, a device illustrated in FIG. 12.

An additive feeding device 500 illustrated in FIG. 12 includes, for example, a scale hopper 502 capable of weighing additive particles and a transport mechanism 504, such as wheels, capable of transporting the hopper. When a plurality of types of additive particles are weighed and fed to a mixing device 600, the additive feeding device moves to weighing and discharging units 512a, 512b, and 512c of cutting machines 506a, 506b, and 506c for the plurality of types of additive particles, so that the cut additives can be weighed into the scale hopper 502 in predetermined amounts. After weighing the plurality of types of additive particles, the additive feeding device 500 may feed the weighed additives to the mixing device 600 for mixing the toner particles with the additive particles.

For the additive feeding device 500, prescriptions for the movement to the weighing and discharging units 512a, 512b, and 512c, the weighing of predetermined amounts, the time of operations, etc. may be set. The prescriptions of the additive feeding device 500 may also be set by a process control computer (not illustrated). The operation of the additive feeding device 500 may be chosen from single operation and ganged operation in conjunction with other steps.

From the viewpoint of transferability and image unevenness suppressibility, an internal temperature Te of the device at the completion of mixing in the mixing step is preferably “the glass transition temperature Tg of the amorphous resin−30° C.” or higher and “the glass transition. temperature Tg of the amorphous resin−5° C.” or lower, more preferably “The glass transition temperature Tg of the amorphous resin−25° C.” or higher and “the glass transition temperature Tg of the amorphous resin−10° C.” or lower.

From the viewpoint of transferability and image unevenness suppressibility, the mixing time of the mixing step is preferably 1 minute or more and 60 minutes or less, more preferably 2 minutes or more and 40 minutes or less, particularly preferably 5 minutes or more and 30 minutes or less.

From the viewpoint of transferability and image unevenness suppressibility, when Te is an internal temperature of the device at the completion of mixing in the mixing step, and Ta is an average temperature in the device during a time period from two minutes after start of the mixing until completion of the mixing, |Ten−Te1|≤10° C. and |Tan−Ta1|≤10° C. are preferably always satisfied, |Ten−Te1|≤8° C. and |Tan−Ta1|≤8° C. are more preferably always satisfied, and |Ten−Te1|≤5° C. and |Tan−Ta1|≤5° C. are particularly preferably always satisfied, where Te1 and Ta1 are Te and Ta, respectively, of first mixing in the case where the mixing step is continuously performed twice or more, Ten and Tan are Te and Ta, respectively, of nth mixing.

Preferred features of components such as a binder resin, a release agent, and a colorant contained in the toner particles containing an amorphous resin in the mixing step will each be described later.

The additive particles in the mixing step may be, for example, external additives for toners.

Examples of the additive particles include inorganic particles and organic particles.

Examples of the inorganic particles include SiO₂, TiO₂, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄.

The surface of inorganic particles may be subjected to hydrophobic treatment. The hydrophobic treatment may be performed, for example, by immersing the inorganic particles in a hydrophobic agent. Non-limiting examples of the hydrophobic agent include silane coupling agents, silicone oil, titanate coupling agents, and aluminum coupling agents. These hydrophobic agents may be used alone or in combination of two or more.

The amount of hydrophobic agent may be, for example, 1 part by mass or more and 10 parts by mass or less relative to 100 parts by mass of the inorganic particles.

Other examples of the additive particles include resin particles (particles of resins such as polystyrene, polymethyl methacrylate (PMMA), and melamine resins) and cleaning active agents (e.g., particles of fatty acid metal salts such as zinc stearate and particles of fluoropolymers).

In particular, for the effects in the exemplary embodiment to be further produced, the additive particles preferably include one or more types of large-size additive particles having an arithmetic average particle size of 60 nm or more and one or more types of small-size additive particles having an arithmetic average particle size of less than 60 cm, more preferably include one or more types of large-size additive particles having an arithmetic average particle size of 60 nm or more and two or more types of small-size additive particles having an arithmetic average particle size of less than 60 nm, and particularly preferably include one or two types of large-size additive particles having an arithmetic average particle size of 60 nm or more and two or three types of small-size additive particles having an arithmetic average particle size of less than 60 nm.

From the viewpoint of transferability and image unevenness suppressibility, the arithmetic average particle size of the large-size additive particles is preferably 70 nm or more, more preferably 85 nm or more, particularly preferably 100 nm or more.

From the viewpoint of transferability and image unevenness suppressibility, the upper limit of the arithmetic average particle size of the large-size additive particles is preferably 8 μm or less, more preferably 5.0 μm or less, still more preferably 300 nm or less, particularly preferably 200 nm or less.

Furthermore, from the viewpoint of transferability and image unevenness suppressibility, the arithmetic average particle size of the small-size additive particles is preferably 5 nm or more and less than 60 cm, more preferably 5 nm or more and 40 nm or less, particularly preferably 5 nm or more and 30 nm or less.

The arithmetic average particle size of the additive particles in the exemplary embodiment is measured as follows: an image is captured with a scanning electron microscope (S-4100 manufactured by Hitachi, Ltd.); the captured image is imported into image processing analysis software WinRoof (manufactured by Mitani Corporation), the area of each particle is determined by image analysis, and an equivalent circle diameter (nm) is determined from the area; and the arithmetic average of equivalent circle diameters of 100 or more particles is calculated to determine the arithmetic average particle size.

For the effects in the exemplary embodiment to be further produced, the additive particles may include inorganic oxide particles. The additive particles preferably include large-size inorganic oxide particles having an arithmetic average particle size of 60 nm or more and small-size inorganic oxide particles having an arithmetic average particle size of less than 60 nm, more preferably include one or more types of large-size inorganic oxide particles having an arithmetic average particle size of 60 nm or more and two or more types of small-size inorganic oxide particles having an arithmetic average particle size of less than 60 nm, and particularly preferably include one or two types of large-size inorganic oxide particles having an arithmetic average particle size of 60 nm or more and two or three types of small-size inorganic oxide particles having an arithmetic average particle size o less than 60 nm.

Examples of the inorganic oxide particles include silica particles, titania particles, silica-titania composite particles, and alumina particles. Of these, at least one type of particles, selected from the group consisting of silica particles, titania particles, and silica-titania composite particles are preferred, and silica particles are particularly preferred.

The additive particles may also be tatty acid metal salt particles. Examples of the fatty acid metal salt particles include particles of salts of fatty acids (e.g., fatty acids such as stearic acid, 12-hydroxystearic acid, behenic acid, montanic acid, lauric acid, and other organic acids) and metals (e.g., calcium, zinc, magnesium, aluminum, and other metals (such as Na and Li)).

Specific examples of the fatty acid metal salt particles include particles of zinc stearate, magnesium stearate, calcium stearate, ferric stearate, copper stearate, magnesium palmitate, calcium palmitate, manganese oleate, lead oleate, zinc laurate, zinc palmitate, and the like.

Of these, the fatty acid metal salt particles are preferably zinc stearate particles from the viewpoint of lubricity, hydrophobicity, wettability, etc. The amount of additive particles added is not particularly limited, but from she viewpoint of transferability and image unevenness suppressibility, it is preferably 0.01 mass % or more and 10 mass % or less, more preferably 0.01 mass % or more and 8 mass % or less, relative to the total mass of the toner particles.

From the viewpoint of transferability and image unevenness suppressibility, the amount of large-size additive particles added is preferably 0.5 mass % or more and 10 mass % or less, more preferably 1.0 mass % or more and 8 mass % or less, still more preferably 1.5 mass % or more and 6 mass % or less, relative to the total mass of the toner particles.

From the viewpoint of transferability and image unevenness suppressibilty, the amount of small-size additive particles added is preferably 0.01 mass % or more and 5 mass % or less, more preferably 0.01 mass % or more and 2.0 mass % or less, relative to she total mass of the toner particles.

Furthermore, in the mixing step, the amount of large-size additive particles added is preferably larger than the amount of small-size additive particles added, from the viewpoint of transferability and image unevenness suppressibility.

In the toner obtained by the mixing in the mixing step, the free ratio representing the percentage of the additive particles not adhering to the toner particles is preferably 60% or less, more preferably 55% or less, particularly preferably 10% or more and 50% or less, from the viewpoint of transferability and image unevenness suppressibility.

In addition, in the toner obtained by the mixing in the mixing step, the strong adhesion ratio representing the percentage of the large-size external additive adhering to the toner that has been subjected to ultrasonic separation treatment is preferably 30% or less, more preferably 20% or less, still more preferably 1% or more and 10% or less, from the viewpoint of transferability and image unevenness suppressibility.

Furthermore, in the toner obtained by the mixing in the mixing step, the strong adhesion ratio representing the percentage of the small-size external additive adhering to the toner that has been subjected to ultrasonic separation treatment is preferably 80% or less, more preferably 20% or more and 70% or less, particularly preferably 25% or more and 60% or less, from the viewpoint of transferability and image unevenness suppressibility.

In the toner obtained by the mixing in the mixing step, preferably, the free ratio representing the percentage of the additive particles not adhering to the toner particles is 60% or less, the strong adhesion ratio representing the percentage of the large-size external additive adhering to the toner that has been subjected to ultrasonic separation treatment is 30% or less, and the strong adhesion ratio representing the percentage of the small-size external additive adhering to the toner that has been subjected to ultrasonic separation treatment is 80% or less, from the viewpoint of transferability and image unevenness suppressibility.

The method for producing an electrostatic image developing toner according to the exemplary embodiment may further include known steps other than the mixing step. Specifically, for example, the steps described below may be included.

The method for producing an electrostatic image developing toner according to the exemplary embodiment may include a preparation step of preparing toner particles containing an amorphous resin.

The toner particles may be produced by a dry process (e.g., kneading pulverization) or a wet process (e.g., aggregation and coalescence, suspension polymerization, or dissolution suspension). Not only these processes but any known process may be used to produce the toner particles.

Of these, for easy preparation of toner particles that provide high image quality and high reliability, the toner particles are preferably obtained by aggregation and coalescence.

Specifically, for example, when the toner particles are produced by aggregation and coalescence, the toner particles are produced by the following steps:

a step (resin particle dispersion preparing step) of preparing an amorphous resin particle dispersion in which amorphous resin particles are dispersed and a crystalline resin particle dispersion in which crystalline resin particles are dispersed;

a step (first aggregated particle forming step) of aggregating the amorphous resin particles (and optionally the crystalline resin particles, colorant particles, release agent particles, etc.) in the amorphous resin particle dispersion (optionally in a dispersion mixture with the crystalline resin particle dispersion, a colorant particle dispersion, and a release agent particle dispersion) to form first aggregated particles;

a step (second aggregated particle forming step) of, after preparing an aggregated particle dispersion in which the first aggregated particles are dispersed, mixing the aggregated particle dispersion with the amorphous resin particle dispersion and aggregating the first aggregated particles and the amorphous resin particles such that the amorphous resin particles adhere to the surface of the first aggregated particles, thereby forming second aggregated particles; and

a step (fusion and coalescence step) of heating the aggregated particle dispersion in which the second aggregated particles are dispersed to fuse and coalesce the aggregated particles, thereby forming toner particles.

The steps will each be described below in detail.

Although a method for producing toner particles containing a coloring agent and a release agent will be described below, the coloring agent and the release agent are optional. It should be understood that additives other than coloring agents and release agents may also be used.

### Resin Particle Dispersion Preparing Step

First, resin particle dispersions (an amorphous resin particle dispersion and a crystalline resin particle dispersion) in each of which resin particles serving as a binder resin are dispersed as well as, for example, a coloring agent particle dispersion in which coloring agent particles are dispersed and a release agent particle dispersion in which release agent particles are dispersed are prepared.

The resin particle dispersions are each prepared, for example, by dispersing resin particles in a dispersion medium with a surfactant.

Examples of the dispersion medium used to prepare each resin particle dispersion include aqueous media.

Examples of the aqueous media include water, such as distilled water and ion-exchanged water, and alcohols. These aqueous media may be used alone or in combination of two or more.

Examples of the surfactant include anionic surfactants such as sulfate ester salts, sulfonate salts, phosphate esters, and soaps; cationic surfactants such as amine salts and quaternary ammonium salts; and nonionic surfactants such as polyethylene glycol, alkylphenol-ethylene oxide adducts, and polyhydric alcohols. Of these, anionic surfactants and cationic surfactants are particularly preferred. Nonionic surfactants may be used in combination with anionic surfactants or cationic surfactants.

These surfactants may be used alone or in combination of two or more.

In preparing each resin particle dispersion, the resin particles may be dispersed in the dispersion medium, for example, by a commonly-used dispersion technique using a rotary shear homogenizer or a media mill such as a ball mill, a sand mill, or a Dyno-Mill. Depending on the type of resin particles, the resin particles may be dispersed in the resin particle dispersion, for example, by phase-inversion emulsification.

Phase-inversion emulsification is a process involving dissolving a resin of interest in a hydrophobic organic solvent capable of dissolving the resin, neutralizing the organic continuous phase (O-phase) by adding a base thereto, and then adding an aqueous medium (W-phase) to cause resin conversion (i.e., phase inversion) from water-in-oil (W/O) to oil-in-water (O/W) and form a discontinuous phase, thereby dispersing the resin in the form of particles in the aqueous medium.

The volume-average particle size of the resin particles dispersed in each resin particle dispersion is, for example, preferably 0.01 μm or more and 1 μm or less, more preferably 0.08 μm or more and 0.8 μm or less, still more preferably 0.1 μm or more and 0.6 μm or less.

The volume-average particle size of the resin particles is determined as follows. A particle size distribution is obtained using a laser diffraction particle size distribution analyzer (e.g., LA-700 manufactured by Horiba, Ltd.) and is divided into particle size classes (channels). A cumulative volume distribution is drawn from smaller particle sizes. The volume-average particle size D50v measured as the particle size at which the cumulative volume is 50% of all particles. The volume-average particle sizes of particles in other dispersions are determined in the same manner.

The content of the resin particles in each resin particle dispersion is, for example, preferably 5 mass % or more and 50 mass % or less, more preferably 10 mass % or more and 40 mass % or less.

For example, the coloring agent particle dispersion and the release agent particle dispersion are prepared in the same manner as the resin particle dispersions. That is, the volume-average particle size, the dispersion medium, the dispersion technique, and the content of the particles in the resin particle dispersions also apply to coloring agent particles dispersed in the coloring agent particle dispersion and release agent particles dispersed in the release agent particle dispersion.

### First Aggregated Particle Forming Step

Next, the amorphous resin particle dispersion is mixed with the coloring agent particle dispersion and the release agent particle dispersion.

The amorphous resin particles, the coloring agent particles, and the release agent particles are then allowed to undergo heteroaggregation in the mixed dispersion to form first aggregated particles including the amorphous resin particles, the coloring agent particles, and the release agent particle. The first aggregated particles have a particle size close to that of the desired toner particles.

Specifically, the first aggregated particles are formed, for example, by adding an aggregating agent to the mixed dispersion, adjusting the mixed dispersion to an acidic pH (e.g., a pH of 2 to 5), optionally adding a dispersion stabilizer, and then heating the mixed dispersion to aggregate the particles dispersed therein. The mixed dispersion is heated to the glass transition temperature of the resin particles (e.g., the glass transition temperature of the resin particles −30° C. to the glass transition temperature of resin the particles −10° C.)

The first aggregated particle forming step may be performed, for example, by adding an aggregating agent to the mixed dispersion at room temperature (e.g., 25° C.) with stirring using a rotary shear homogenizer, adjusting the mixed dispersion to an acidic pH (e.g., a pH of 2 to 5), optionally adding a dispersion stabilizer, and then heating the mixed dispersion.

Examples of the aggregating agent include surfactants having polarity opposite to that of the surfactant used as a dispersant added to the mixed dispersion, inorganic metal salts, and metal complexes with a valence of two or more. In particular, the use of a metal complex as the aggregating agent may reduce the amount of surfactant used, which may improve the charging characteristics.

Additives that form a complex or a similar linkage together with metal ions of the aggregating agent may optionally be used. An example of such additives is a chelating agent.

Examples of the inorganic metal salts include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

The chelating agent may be a water-soluble chelating agent. Examples of the chelating agent include oxycarboxylic acids such as tartaric acid, citric acid, and gluconic acid; iminodiacetic acid (IDA); nitrilotriacetic acid (NTA); and ethylenediaminetetraacetic acid (EDTA).

The amount of chelating agent added is, for example, preferably 0.01 parts by mass or more and 5.0 parts by mass or less, more preferably 0.1 parts by mass or more and less than 3.0 parts by mass, relative to 100 parts by mass of the amorphous resin particles.

### Second Aggregated Particle Forming Step

After an aggregated particle dispersion in which the first aggregated particles are dispersed is prepared, the aggregated particle dispersion and the amorphous resin particle dispersion are mixed together.

In the dispersion in which the first aggregated particles and the amorphous resin particles are dispersed, the amorphous resin particles are aggregated onto the surface of the first aggregated particles.

Specifically, for example, when the particle size of the first aggregated particles has reached the desired particle size in the first aggregated particle forming step, the amorphous resin particle dispersion is added to the first aggregated particle dispersion, and the resulting dispersion is heated at a temperature equal to or lower than the glass transition temperature of the amorphous resin particles.

The pH of the dispersion is then adjusted to stop the progress of aggregation.

### Fusion And Coalescence Step

Next, the second aggregated particle dispersion in which the second aggregated particles are dispersed is heated, for example, to a temperature equal so or higher than the glass transition temperature of the amorphous resin particles (e.g., a temperature 10° C. to 30° C. or more higher than the glass transition temperature of the amorphous resin particles) to fuse and coalesce the aggregated particles, the forming toner particles.

Through the above steps, toner particles are obtained.

After the completion of the fusion and coalescence step, the toner particles formed in the solution are subjected to known washing, solid-liquid separation, and drying steps to obtain dry toner particles.

The washing step may be performed by sufficient displacement washing with ion-exchanged water in terms of charging characteristics. Although the solid-liquid separation step may be performed by any process, a process such as suction filtration or pressure filtration may be used in terms of productivity. Although the drying step may also be performed by any process, a process such as freeze drying, flash drying, fluidized bed drying, and vibrating fluidized bed drying may be used in terms of productivity.

Components contained in the electrostatic image developing toner other than the above-described components will be described below in detail.

### Binder Resin

The binder resin preferably contains an amorphous resin, and more preferably contains an amorphous resin and a crystalline resin from the viewpoint of image strength and suppression of density unevenness in images to be obtained. That is, in the aggregation step, amorphous resin particles and crystalline resin particles are more preferably contained as the binder resin particles.

The toner particles contain an amorphous resin.

Furthermore, the toner particles may be core-shell toner particles.

Here, the term “amorphous resin” refers to a resin that exhibits only a stepwise endothermic change instead of a distinct endothermic peak in thermal analysis measurement using differential scanning calorimetry (DSC) and that is solid at normal temperature and thermally plasticized at a temperature higher than or equal to its glass transition temperature.

The term “crystalline resin” refers to a resin that exhibits a distinct endothermic peak instead of a stepwise endothermic change in differential scanning calorimetry (DSC).

Specifically, for example, the crystalline resin means that the half-width of an endothermic peak measured at a temperature increase rate of 10° C./min is 10° C. or less, and the amorphous resin means a resin having a half-width of more than 10° C. or a resin haying no distinct endothermic peaks.

The amorphous resin will be described.

Examples of the amorphous resin include known amorphous resins such as amorphous polyester resins, amorphous vinyl resins (e.g., styrene-acrylic resins), epoxy resins, polycarbonate resins, and polyurethane resins. Of these, from the viewpoint of suppression of density unevenness and voids in images to be obtained, amorphous polyester resins and amorphous vinyl resins (particularly, styrene-acrylic resins) are preferred, and amorphous polyester resins are more preferred.

As the amorphous resin, a combination of an amorphous polyester resin and a styrene-acrylic resin may also be used.

Examples of the amorphous polyester resin include polycondensates of polycarboxylic acids with polyhydric alcohols. The amorphous polyester resin for use may be a commercially available product or may be synthesized.

Examples of the polycarboxylic acids include aliphatic dicarboxylic acids (e.g., oxalic acid, malonic acid, maleic acid, fumaric acid, citraconic acid, itaconic acid, qiutaconic acid, succinic acid, alkenylsuccinic acid, adipic acid, and sebacic acid), alicyclic dicarboxylic acids (e.g., cyclohexanedicarboxylic acid), aromatic dicarboxylic acids (e.g., terephthalic acid, isophthalic acid, phthalic acid, and naphthalenedicarboxylic acid), anhydrides thereof, and lower (e.g., C1 to C5) alkyl esters thereof. Of these, aromatic dicarboxylic acids are preferred.

The polycarboxylic acid may be a combination of a dicarboxylic acid with a trivalent or higher valent carboxylic acid having a crosslinked or branched structure. Examples of the trivalent or higher valent carboxylic acid include trimellitic acid, pyromellitic acid, anhydrides thereof, and lower (e.g., C1 to C5) alkyl esters thereof.

These polycarboxylic acids may be used alone or in combination of two or more.

Examples of the polyhydric alcohols include aliphatic diols (e.g., ethylene glycol, diethylene glycol, triethylene glycol, propylene glycol, butanediol, hexanediol, and neopentyl glycol), alicyclic diols (e.g., cyclohexanediol, cyclohexanedimethanol, and hydrogenated bisphenol A), and aromatic diols (e.g., ethylene oxide adducts of bisphenol A and propylene oxide adducts of bisphenol A). Of these, aromatic diols and alicyclic diols are preferred, and aromatic diols are more preferred.

The polyhydric alcohol may be a combination of a diol with a trivalent or higher valent polyhydric alcohol having a crosslinked or branched structure. Examples of the trivalent or higher valent polyhydric alcohol include glycerol, trimethylolpropane, and pentaerythritol.

These polyhydric alcohols may be used alone or in combination of two or more.

The amorphous polyester resin is produced by a known method. Specifically, the amorphous resin is produced, for example, by performing a polymerization reaction at a temperature of 180° C. to 230° C., optionally while removing water and alcohol produced during condensation by reducing the pressure in the reaction system. If any starting monomer is insoluble or incompatible at the reaction temperature, it may be dissolved by adding a high-boiling solvent as a solubilizer. In this case, the polycondensation reaction is performed while distilling off the solubilizer. If the copolymerization reaction is performed using a poorly compatible monomer, the poorly compatible monomer may be condensed with an acid or alcohol to be polycondensed with the monomer before being polycondensed with the major components.

The binder resin, particularly the amorphous resin, may be a styrene-acrylic resin.

The styrene-acrylic resin is a copolymer obtained by copolymerization of at least a styrene monomer (a monomer having a styrene backbone) and a (meth)acrylic monomer (a monomer having a (meth)acrylic group, preferably a monomer having a (meth)acryloxy group). The styrene-acrylic resin, for example, includes a copolymer of a styrene monomer and a (meth)acrylate monomer.

The acrylic resin moiety in the styrene-acrylic resin is a substructure formed by polymerization of one or both of an acrylic monomer and a methacrylic monomer. The expression “(meth)acrylic” is meant to include both “acrylic” and “methacrylic”.

Specific examples of the styrene monomer include styrene, alkyl-substituted styrenes (e.g., α-methylstyrene, 2-methylstyrene, 3-methylstyrene, 4-methylstyrene, 2-ethylstyrene, 3-ethylstyrene, and 4-ethylstyrene), halogen-substituted styrenes (e.g., 2-chlorostyrene, 3-chlorostyrene, and 4-chlorostyrene), and vinylnaphthalene. These styrene monomers may be used alone or in combination of two or more.

Of these styrene monomers, styrene is preferred for its ease of reaction, ease of reaction control, and availability.

Specific examples of the (meth)acrylic monomer include (meth)acrylic acid and (meth)acrylates. Examples of the (meth)acrylates include alkyl (meth)acrylates (e.g., methyl (meth)acrylate, ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (mach) acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, cyclohexyl (meth)acrylate, and t-butylcyclohexyl (meth)acrylate), aryl (meth)acrylates (e.g., phenyl (meth)acrylate, biphenyl (meth)acrylate, diphenylethyl (meth)acrylate, t-butylphenyl (meth)acrylate, and terphenyl (meth)acrylate), dimethylaminoethyl (meth)acrylate, diethylaminoethyl (meth)acrylate, methoxyethyl (meth)acrylate, 2-hydroxyethyl (meth)acrylate, β-carboxyethyl (meth)acrylate, and (meth)acrylamides. These (meth)acrylate monomers may be used alone or in combination of two or more.

Of these (meth)acrylates among the (meth)acrylic monomers, (meth)acrylates having an alkyl group having 2 to 14 (preferably 2 to 10, more preferably 3 to 8) carbon atoms are preferred in terms of fixability.

In particular, n-butyl (meth)acrylate is preferred, and n-butyl acrylate is particularly preferred.

The copolymerization ratio (by mass) of the styrene monomer to the (meth)acrylic monomer (styrene monomer/(meth)acrylic monomer) is preferably, but not necessarily, 85/15 to 70/30.

The styrene-acrylic resin may have a crosslinked structure. The styrene-acrylic resin having a crosslinked structure may be, for example, a copolymer of at least a styrene monomer, a (meth)acrylate monomer, and a crosslinkable monomer.

Examples of the crosslinkable monomer include bi- or more functional cross-linking agents.

Examples of bifunctional cross-linking agents include divinylbenzene, divinylnaphthalene, di(meth)acrylate compounds (e.g., diethylene glycol di(meth)acrylate, methylenebis(meth)acrylamide, decanediol diacrylate, and glycidyl (meth)acrylate), polyester di(meth)acrylates, and 2-([1′-methylpropylideneamino]carboxyamino)ethyl (meth)acrylate.

Examples of polyfunctional crosslinking agents include tri(meth)acrylate compounds (e.g., pentaerythritol tri(meth)acrylate, trimethylolethane tri(meth)acrylate, and trimethylolpropane tri(meth)acrylate), tetra(meth)acrylate compounds (e.g., pentaerythritol tetra(meth)acrylate and oligoester (meth)acrylates), 2,2-bis(4-methacryloxypolyethoxyphenyl) propane, diallyl phthalate, triallyl cyanurate, triallyl isocyanurate, triallyl trimellitate, and diallyl chlorendate.

To reduce the occurrence of a decrease in image density and also reduce the occurrence of unevenness in image density, and in view of fixability, the crosslinkable monomer is preferably a bi- or more functional (meth)acrylate compound, more preferably a bifunctional (meth)acrylate compound, still more preferably a bifunctional (meth)acrylate compound having an alkylene group having 6 to 20 carbon atoms, particularly preferably a bifunctional (meth)acrylate compound having a linear alkylene group having 6 to 20 carbon atoms.

The copolymerization ratio (by mass) of the crosslinkable monomer to all monomers (crosslinkable monomer/all monomers) is preferably, but not necessarily, 2/1,000 to 20/1,000.

The styrene-acrylic resin may be produced by any method, and various polymerization methods (e.g., solution polymerization, precipitation polymerization, suspension polymerization, bulk polymerization, and emulsion polymerization) may be used. The polymerization reaction is carried out by using a known process (e.g., a batch process, a semi-continuous process, or a continuous process).

The proportion of the styrene-acrylic resin in all binder resins is preferably 0 mass % or more and 20 mass % or less, more preferably 1 mass % or more and 15 mass % or less, still more preferably 2 mass % or more and 10 mass % or less.

The proportion of the amorphous resin in all binder resins is preferably 60 mass % or more and 98 mass % or less, more preferably 65 mass % or more and 95 mass % or less, still more preferably 70 mass % or more and 90 mass % or less.

The properties of the amorphous resin will be described.

The glass transition temperature (Tg) of the amorphous resin is preferably 50° C. or higher and 80° C. or lower, more preferably 50° C. or higher and 65° C. or lower.

The glass transition temperature is determined from a DSC curve obtained by differential scanning calorimetry (DSC). More specifically, the glass transition temperature is determined in accordance with “Extrapolation Glass Transition Onset Temperature” described in Determination of Glass Transition Temperature in JIS K 7121-1987 “Testing Methods for Transition Temperatures of Plastics”.

The weight-average molecular weight (Mw) of the amorphous resin is preferably 5,000 or more and 1,000,000 or less, more preferably 7,000 or more and 500,000 or less.

The number-average molecular weight (Mn) of the amorphous resin is preferably 2,000 or more and 100,000 or less.

The molecular weight distribution Mw/Mn of the amorphous resin is preferably 1.5 or more and 100 or less, more preferably 2 or more and 60 or less.

The weight-average molecular weight and the number-average molecular weight are determined by gel permeation chromatography (GPC). The molecular weight determination by GPC is performed using an HLC-8120GPC system manufactured by Tosoh Corporation as a measurement apparatus, a TSKgel SuperHM-M column (15 cm) manufactured by Tosoh Corporation, and a THF solvent. The weight-average molecular weight and the number-average molecular weight are determined using a molecular weight calibration curve prepared from the measurement results relative to monodisperse polystyrene standards.

The crystalline resin will be described.

Examples of the crystalline resin include known crystalline resins such as crystalline polyester resins and crystalline vinyl resins (e.g., polyalkylene resins and long-chain alkyl (meth)acrylate resins). Of these, crystalline polyester resins are preferred from the viewpoint of suppression of density unevenness and voids in images to be obtained.

Examples of the crystalline polyester resin include polycondensates of polycarboxylic acids with polyhydric alcohols. The crystalline polyester resin for use may be a commercially available product or may be synthesized.

To easily form a crystalline structure, the crystalline polyester resin may be a polycondensate prepared from linear aliphatic polymerizable monomers rather than from aromatic polymerizable monomers.

Examples of the polycarboxylic acids include aliphatic dicarboxylic acids (e.g., oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (e.g., dibasic acids such as phthalic acid, isophthalic acid, terephthalic acid, and naphthalene-2,6-dicarboxylic acid), anhydrides thereof, and lower (e.g., C1 to C5) alkyl esters thereof.

The polycarboxylic acid may be a combination of a dicarboxylic acid with a trivalent or higher valent carboxylic acid having a cross-linked or branched structure. Examples of the tricarboxylic acid include aromatic carboxylic acids (e.g., 1,2,3-benzenetricarboxylic acid, 1,2,4-benzenetricarboxylic acid, and 1,2,4-naphthalenetricarboxylic acid), anhydrides thereof, and lower (e.g., C1 to C5) alkyl esters thereof.

The polycarboxylic acid may be a combination of such a dicarboxylic acid with a dicarboxylic acid having a sulfonic group or a dicarboxylic acid having an ethylenic double bond.

These polycarboxylic acids may be used alone or in combination of two or more.

Examples of the polyhydric alcohols include aliphatic diols (e.g., linear aliphatic diols having 7 to 20 main-chain carbon atoms). Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-1,12-dodecanediol, 1,13-tridecanediol, 1,14-tetradecanediol, 1,18-octadecanediol, and 1,14-eicosanedecanediol. Of these, 1,8-octanediol, 1,9-nonanediol, and 1,10-decanediol are preferred.

The polyhydric alcohol may be a combination of a diol with a trivalent or higher valent alcohol having a cross-linked or branched structure. Examples of the trivalent or higher valent alcohol include glycerol, trimethylolethane, trimethylolpropane, and pentaerythritol.

These polyhydric alcohols may be used alone or in combination of two or more.

The amount of aliphatic diol in the polyhydric alcohol may be 80 mol % or more and is preferably 90 mol % or more.

The melting temperature of the crystalline polyester resin preferably 50° C. or more and 100° C. or less, more preferably 55° C. or more and 90° C. or less, still more preferably 60° C. or more and 85° C.

The melting temperature of the crystalline polyester resin is determined from a DSC curve obtained by differential scanning calorimetry (DSC) in accordance with “Melting Peak Temperature” described in Determination of Melting Temperature of JIS K 7121: 1987 “Testing Methods for Transition Temperatures of Plastics”.

The weight-average molecularweight (Mw) of the crystalline polyester resin is preferably 6,000 or more and 35,000 or less.

The crystalline polyester resin is produced, for example, by a known method, as with the amorphous polyester resin.

From the viewpoint of easy formation of a crystalline structure and so good compatibility with the amorphous polyester resin that improves image fixability, the crystalline polyester resin may be a polymer of an α,ω-linear aliphatic dicarboxylic acid and an α,ω-linear aliphatic diol.

The α,ω-linear aliphatic dicarboxylic acid is preferably an α,ω-linear aliphatic dicarboxylic acid in which the two carboxy groups are linked through an alkylene group having 3 to 14 carbon atoms. The number of carbon atoms in the alkylene group is more preferably 4 so 12, still more preferably 6 to 10.

Examples of the α,ω-linear aliphatic dicarboxylic acid include succinic acid, olutaric acid, adipic acid, 1,6-hexanedicarboxylic acid (trivial name: suberic acid), 1,7-heptanedicarboxylic acid (trivial name: azelaic acid), 1,8-octanedicarboxylic acid (trivial name: sebacic acid), 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid, among which 1,6-hexanedicarboxylic acid, 1,7-heptanedicarboxylic acid, 1,8-octanedicarboxylic acid, 1,9-nonanedicarboxylic acid, and 1,10-decanedicarboxylic acid are preferred.

These α,ω-linear aliphatic dicarboxylic acids may be used alone or in combination of two or more.

The α,ω-linear aliphatic diol is preferably an α,ω-linear aliphatic dial in which the two hydroxy groups are linked through an alkylene group having 3 to 14 carbon atoms. The number of carbon atoms in the alkylene group is more preferably 4 to 12, still more preferably 6 to 10.

Examples of the α,ω-linear aliphatic dial include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dadecanediol, 1,14 tetradecanediol, and 1,18-octadecanediol, among which 1,6-hexanediol, 1,7-heptanediol, 1,8-octanediol, 1,9-nonanediol, and 1,10-decanediol are preferred.

These α,ω-linear aliphatic diols may be used alone or in combination of two or more.

From the viewpoint of easy formation of a crystalline structure and so good compatibility with the amorphous polyester resin that improves image fixability, the polymer of an α,ω-linear aliphatic dicarboxylic acid and an α,ω-linear aliphatic dial is preferably a polymer of at least one selected from the group consisting of 1,6-hexanedicarboxylic acid, 1,7-heptanedicarboxylic acid, 1,8-octanedicarboxylic acid, 1,9-nonanedicarboxylic acid, and 1,10-decanedicarboxylic acid and at least one selected from the group consisting of 1,6-hexanediol, 1,7-heptanediol, 1, 8-octanediol, 1,9-nonanediol, and 1,10-decanediol, more preferably a polymer of 1,10-decanedicarboxylic acid and 1,6-hexanediol.

The proportion of the crystalline resin in all binder resins is preferably 1 mass % or more and 20 mass % or less, more preferably 2 mass % or more and 15 mass % or less, still more preferably 3 mass % or more and 10 mass % or less.

### Other Binder Resins

Examples of the binder resin include homopolymers of monomers such as ethylenically unsaturated nitriles (e.g., acrylonitrile and methacrylonitrile), vinyl ethers (e.g., vinyl methyl ether and vinyl isobutyl ether), vinyl ketones (e.g., vinyl methyl ketone, vinyl ethyl ketone, and vinyl isopropenyl ketone), and olefins (e.g., ethylene, propylene, and butadiene) and copolymers of two or more of these monomers.

Other examples of the binder resin include non-vinyl resins such as epoxy resins, polyurethane resins, polyimide resins, cellulose resins, polyether resins, and modified rosin; mixtures of these non-vinyl resins and the above vinyl resins; and graft polymers obtained by polymerizing vinyl monomers in the presence of these non-vinyl resins.

These binder resins may be used alone or in combination of two or more.

The content of the binder resin is preferably 40 mass % or more and 95 mass % or less, more preferably 50 mass % or more and 90 mass % or less, still more preferably 60 mass % or more and 85 mass % or less, relative to the total amount of the toner particles.

### Release Agent

Examples of the release agent include hydrocarbon waxes; natural waxes such as carnauba wax, rice wax, and Candelilla wax; synthetic or mineral/petroleum waxes such as montan wax; and ester waxes such as fatty acid esters and montanic acid esters, but are not limited thereto.

From the viewpoint of suppression of density unevenness and voids in images to be obtained and so good compatibility with the amorphous polyester resin that improves image fixability, the release agent is preferably an ester wax, more preferably an ester wax produced from a higher fatty acid having 10 to 30 carbon atoms and a monohydric or polyhydric alcohol component having 1 to 30 carbon atoms.

The ester wax is a wax having an ester bond. The ester wax may be a monoester, a diester, a triester, or a tetraester, and any known natural or synthesized ester wax may be employed.

The ester wax may be, for example, an ester compound of a higher fatty acid (e.g., a fatty acid having 10 or more carbon atoms) and a monohydric or polyhydric aliphatic alcohol (e.g., an aliphatic alcohol having 8 or more carbon atoms), the ester compound having a melting temperature of 60° C. or higher and 110° C. or lower (preferably 65° C. or higher and 100° C. or lower, more preferably 70° C. or higher and 95° C. or lower).

Examples of the ester wax include ester compounds of higher fatty acids (e.g., caprylic acid, capric acid, lauric acid, myristic acid, palmitic acid, stearic acid, arachidic acid, behenic acid, and oleic acid) and alcohols (e.g., monohydric alcohols such as methanol, ethanol, propanol, isopropanol, butanol, capryl alcohol, lauryl alcohol, myristyl alcohol, cetyl alcohol, stearyl alcohol, and oleyl alcohol; and polyhydric alcohols such as glycerol, ethylene glycol, propylene glycol, sorbitol, and pentaerythritol). Specific examples include carnauba wax, rice wax, candelilla wax, jojoba oil, Japan tallow, beeswax, Chinese wax, lanolin, and montanic acid ester wax.

The melting temperature of the release agent is preferably 50° C. or higher and 110° C. or lower, more preferably 60° C. or higher and 100° C. or lower.

The melting temperature of the release agent is determined from a DSC curve obtained by differential scanning calorimetry (DSC) in accordance with “Melting Peak Temperature” described in Determination of Melting Temperature of JIS K 7121: 1987 “Testing Methods for Transition Temperatures of Plastics”.

The content of the release agent is preferably 1 mass % or more and 20 mass % or less, more preferably 5 mass % or more and 15 mass % or less, relative to the total amount of the toner particles.

### Colorant

In the aggregation step, the dispersion may further contain colorant particles.

Examples of the colorant include various pigments such as carbon black, chromium yellow, hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and various dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

These colorants may be used alone or in combination of two or more.

Optionally, the colorant may be a surface-treated colorant or may be used in combination with a dispersant. The colorant may be a combination of different colorants.

The content of the colorant is, for example, preferably 1 mass % or more and 30 mass % or less, more preferably 3 mass % or more and 15 mass % or less, relative to the total amount of the toner particles.

### Other Additives

Examples of other additives include well-known additives such as magnetic materials, charge control agents, and inorganic powders. These additives are contained as internal additives in the toner particles.

### Properties of Toner Particles

The toner particles may be toner particles having, what is called, a core-shell structure composed of a core (core particle) and a coating layer (shell layer) covering the core (core-shell particles). The toner particles having a core-shell structure may be composed of, for example, a core and a coating layer, the core containing a binder resin and optionally a colorant, a release agent, and the like, the coating layer containing a binder resin.

In the case of such toner particles having a core-shell structure, from the viewpoint of suppression of deformation of the toner particles, the average thickness of the shell layer preferably 120 nm or more, more preferably 130 nm or more, still more preferably 140 nm or more, and preferably 550 nm or less, more preferably 500 nm or less, still more preferably 400 nm or less.

The average thickness of the shell layer is measured by the following method.

The toner particles are embedded in an epoxy resin, and a section is prepared with a diamond knife or the like. The section prepared is stained with osmium tetraoxide or ruthenium tetroxide in a desiccator. The stained section is observed under a scanning electron microscope (SEM). Sections of ten toner particles are randomly selected in the SEM image. In each toner particle, the thickness of the shell layer is measured at 20 points, and the average value is calculated. The average value of the ten toner particles is used as the average thickness.

The volume-average particle size (D₅₀ᵥ) of the toner is preferably 2 μm or more and 10 μm or less, more preferably 4 μm or more and 8 μm or less.

The volume-average particle size of the toner is measured using a COULTER MULTISIZER II (manufactured by Beckman Coulter, Inc.) and an ISOTON-II electrolyte solution (manufactured by Beckman Coulter, Inc.).

In the measurement, 0.5 mg or more and. 50 mg or less of a test sample is added to 2 mL of a 5 mass % aqueous solution of a surfactant (e.g., sodium alkylbenzenesulfonate) serving as a dispersant. The resulting solution is added to 100 mL or more and 150 mL or less of the electrolyte solution.

The electrolyte solution containing the suspended sample is dispersed with an ultrasonic disperser for one minute, and the particle size of particles having a particle size of 2 μm or more and 60 μm or less is measured with the COULTER MULTISIZER II using an aperture with an aperture size of 100 μm. The number of sampled particles is 50,000.

A volume-based cumulative distribution of the measured particle sizes is drawn from smaller particle sizes. The volume-average particle size D₅₀ᵥ is defined as the particle size at a cumulative volume of 50%.

In the exemplary embodiment, the average circularity of the toner particles is not particularly limited, but for improved cleaning of the toner off the image carrier, it is preferably 0.91 or more and 0.98 or less, more preferably 0.94 or more and 0.98 or less, still more preferably 0.95 or more and 0.97 or less.

In the exemplary embodiment, the circularity of the toner particles is expressed as (peripheral length of circle having the same area as projected particle image)/(peripheral length of projected particle image), and the average circularity of the toner particles is the circularity at a cumulative value of 50% from smaller circularities in a circularity distribution. The average circularity of the toner particles is determined by analyzing at least 3,000 toner particles with a flow particle image analyzer.

The average circularity of the toner particles can be controlled, for example, by adjusting the rate of stirring a dispersion, the temperature of the dispersion, or the retention time in the fusion step.

The amount of release agent in the toner particle surface can be controlled, for example, by adjusting the amount of charged release agent, the type of release agent, or the temperature during melt kneading, or performing a surface treatment with hot air after pulverization.

### Electrostatic Image Developer

An electrostatic image developer according to an exemplary embodiment at least includes a toner produced by the method for producing an electrostatic image developing toner according to the exemplary embodiment.

The electrostatic image developer according to the exemplary embodiment may be a one-component developer including only a toner produced by the method for producing an electrostatic image developing toner according to the exemplary embodiment or a two-component developer including a mixture of the toner and a carrier.

The carrier may be any known carrier. Examples of the carrier include coated carriers obtained by coating the surface of cores formed of magnetic powders with coating resins; magnetic-powder-dispersed carriers obtained by dispersing and blending magnetic powders in matrix resins; and resin-impregnated carriers obtained by impregnating porous magnetic powders with resins.

The magnetic-powder-dispersed carriers and the resin-impregnated carriers may also be carriers obtained by using the constituent particles of the carriers as cores and coating the cores with coating resins.

Examples of the magnetic powders include magnetic metals such as iron, nickel, and cobalt and magnetic oxides such as ferrite and magnetite.

Examples of the coating resins and the matrix resins include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylate copolymers, straight silicone resins containing organosiloxane bonds and modified products thereof, fluorocarbon resins, polyesters, polycarbonates, phenolic resins, and epoxy resins.

The coating resins and the matrix resins may contain conductive particles and other additives.

Examples of the conductive particles include particles of metals such as gold, silver, and copper, carbon black, titanium oxide, zinc oxide, tin oxide, barium sulfate, aluminum borate, and potassium titanate.

An example method for coating the surface of the core with the coating resin is coating with a solution for coating layer formation obtained by dissolving the coating resin and various optional additives in an appropriate solvent. Any solvent may be selected by taking into account factors such as the coating resin used and coating suitability.

Specific methods for coating the core with the coating resin include a dipping method in which the core i.s dipped in the solution for coating layer formation, a spraying method in which the surface of the core is sprayed with the solution for coating layer formation, a fluidized bed method in which the core suspended in an air stream is sprayed with the solution for coating layer formation, and a kneader-coater method in which the carrier core and the solution for coating layer formation are maxed in a kneader-coater and the solvent is removed.

The mixing ratio (mass ratio) of the toner to the carrier in the two-component developer is preferably 1:100 to 30:100, more preferably 3:100 to 20:100.

### Image Forming Apparatus and Image Forming Method

An image forming apparatus according to an exemplary embodiment and an image forming method according to an exemplary embodiment will be described.

The image forming apparatus according to the exemplary embodiment includes an image carrier; a charging unit that charges a surface of the image carrier; an electrostatic image forming unit that forms an electrostatic image on the charged surface of the image carrier; a developing unit that contains an electrostatic image developer and develops, with the electrostatic image developer, the electrostatic image formed on the surface of the image carrier to form a toner image; a transfer unit that transfers the toner image formed on the surface of the image carrier onto a surface of a recording medium; and a fixing unit that fixes the toner image transferred onto the surface of the recording medium.

As the electrostatic image developer, the electrostatic image developer according to the exemplary embodiment is used.

The image forming apparatus according to the exemplary embodiment executes an image forming method (the image forming method according to the exemplary embodiment) including a charging step of charging a surface of an image carrier, an electrostatic image forming step of forming an electrostatic image on the charged surface of the image carrier, a developing step of developing, with the electrostatic image developer according to the exemplary embodiment, the electrostatic image formed on the surface of the image carrier to form a toner image, a transferring step of transferring the toner image formed on the surface of the image carrier onto a surface of a recording medium, and a fixing step of fixing the toner image transferred onto the surface of the recording medium.

The image forming apparatus according to the exemplary embodiment may be a well-known image forming apparatus: for example, a direct-transfer apparatus that transfers a toner image formed on a surface of an image carrier directly to a recording medium; an intermediate-transfer apparatus that first transfers a toner image formed on a surface of an image carrier to a surface of an intermediate transfer body and then transfers the toner image transferred onto the surface of the intermediate transfer body to a surface of a recording medium; an apparatus including a cleaning unit that cleans a surface of an image carrier after the transfer of a toner image and before charging; or an apparatus including an erasing unit that erases charge on a surface of an image carrier by irradiation with erasing light after the transfer of a toner image and before charging.

In particular, an image forming apparatus including a cleaning unit that cleans the surface of an image carrier is suitable. The cleaning unit may be a cleaning blade.

In the case of an intermediate-transfer apparatus, the transfer unit includes, for example, an intermediate transfer body having a surface to which a toner image is transferred, a first transfer unit that transfers a toner image formed on a surface of an image carrier to the surface of the intermediate transfer body, and a second transfer unit that transfers the toner image transferred onto the surface of the intermediate transfer body to a surface of a recording medium.

In the image forming apparatus according to the exemplary embodiment, the section including the developing unit may be, for example, a cartridge structure (process cartridge) attachable to and detachable from the image forming apparatus. For example, a process cartridge including a developing unit containing the electrostatic image developer according to the exemplary embodiment is suitable for use as the process cartridge.

A non-limiting example of the image forming apparatus according to the exemplary embodiment will now be described. The parts illustrated in the drawings are described, and the description of other parts is omitted.

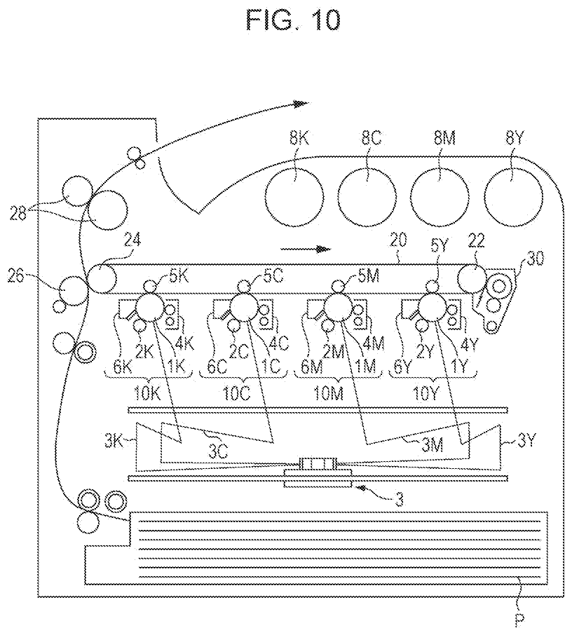

FIG. 10 illustrates a schematic configuration of the image forming apparatus according to the exemplary embodiment.

The image forming apparatus illustrated in FIG. 10 includes first to fourth electrophotographic image forming units 10Y, 10M, 10C, and 10K which respectively output yellow (Y), magenta (M), cyan (C), and black (K) images based on color-separated image data. These image forming units (hereinafter also referred to simply as “units”) 10Y, 10M, 10C, and 10K are arranged side by side at predetermined intervals in the horizontal direction. The units 10Y, 10M, 10C, and 10K may be process cartridges attachable to and detachable from the image forming apparatus.

An intermediate transfer belt 20 serving as the intermediate transfer body extends above the units 10Y, 10M, 10C, and 10K in the figure so as to pass through the units. The intermediate transfer belt 20 is wound around a drive roller 22 and a support roller 24, which are spaced from each other in the horizontal direction in the figure, and is configured to run in the direction from the first unit 10Y toward the fourth unit 10K. The support roller 24 is in contact with the inner surface of the intermediate transfer belt 20. A spring or the like (not shown) applies a force to the support roller 24 in the direction away from the drive roller 22, so that tension is applied to the intermediate transfer belt 20 wound around the rollers 22 and 21. An intermediate transfer body cleaning device 30 is provided on the image carrier side of the intermediate transfer belt 20 so as to face the drive roller 22.

The units 10Y, 10M, 10C, and 10K respectively include developing devices (developing units) 4Y, 4M, 4C, and 4K to which toners of four colors, yellow, magenta, cyan, and black, are respectively supplied from toner cartridges 8Y, 8M, 8C, and 8K.

The first to fourth units 10Y, 10M, 10C, and 10K have the same configuration. Thus, the first unit 10Y, which is disposed upstream in the running direction of the intermediate transfer belt and forms a yellow image, will be described as a representative. The same components as those of the first unit 10Y are denoted by the same reference numerals followed by the letters M (magenta), C (cyan), and K (black) instead of the letter Y (yellow), and a description of the second to fourth units 10M, 10C, and 10K is omitted.

The first unit 10Y includes a photoreceptor 1Y. The photoreceptor 1Y functions as an image carrier and is surrounded by, in sequence, a charging roller 2Y (an example of the charging unit), an exposure device 3 (an example of the electrostatic image forming unit), a developing device 4Y (an example of the developing unit), a first transfer roller 5Y (an example of the first transfer unit), and a photoreceptor cleaning device 6Y (an example of the cleaning unit). The charging roller 2Y charges the surface of the photoreceptor 1Y to a predetermined potential. The exposure device 3 exposes the charged surface to a laser beam 3Y based on a color-separated image signal to form an electrostatic image. The developing device 4Y supplies a charged toner to the electrostatic image to develop the electrostatic image. The first transfer roller 5Y transfers the developed toner image onto the intermediate transfer belt 20. The photoreceptor cleaning device 6Y removes the toner remaining on the surface of the photoreceptor 1Y after the first transfer.

The first transfer roller 5Y is disposed inside the intermediate transfer belt 20 so as to face the photoreceptor 1Y. Furthermore, the first transfer rollers 5Y, 5M, 5C, and 5K are each connected to a bias power supply (not shown) that applies a first transfer bias. The value of transfer bias applied from each bias power supply to each first transfer roller is varied by control of a controller (not shown).

The operation of the first unit 10Y to form a yellow image will now be described.

Prior to the operation, the charging roller 2Y charges the surface of the photoreceptor 1Y to a potential of −600 V to −800 V.

The photoreceptor 1Y is formed of a conductive substrate (for example, having a volume resistivity of 1×10⁻⁶ Ωcm or less at 20° C.) and a photosensitive layer stacked on the substrate. The photosensitive layer, which normally has high resistivity (resistivity of common resins), has toe property of, upon irradiation with the laser beam 3Y, changing its resistivity in an area irradiated with the laser beam. The laser beam. 3Y is emitted toward the charged surface of the photoreceptor 1Y via the exposure device 3 on the basis of yellow image data sent from the controller (not sown). The laser beam 3Y is applied to the photosensitive layer on the surface of the photoreceptor 1Y, as a result of which an electrostatic image with a yellow image pattern is formed on the surface of the photoreceptor 1Y.

The electrostatic image is an image formed on the surface of the photoreceptor 1Y by charging. Specifically, the electrostatic image is what is called a negative latent image formed in the following manner: in the area or the photosensitive layer irradiated with the laser beam 3Y, the resistivity drops, and the charge on the surface of the photoreceptor 1Y dissipates from the area, while the charge remains in the area not irradiated with the laser beam 3Y.

As the photoreceptor 1Y rotates, the electrostatic image formed on the photoreceptor 1Y is brought to a predetermined development position. At the development position, the electrostatic image on the photoreceptor 1Y is visualized (developed) as a toner image by the developing device 4Y.

The developing device 4Y contains, for example, an electrostatic image developer containing at least a yellow toner and a carrier. The yellow toner is frictionally charged as it is stirred inside the developing device 4Y, and thus has a charge with the same polarity (negative) as that of the charge on the photoreceptor 1Y and is held on a developer roller (an example of the developer carrier). As the surface of the photoreceptor 1Y passes through the developing device 4Y, the yellow toner is electrostatically attached to the neutralized latent image portion on the surface of the photoreceptor 1Y to develop the latent image. The photoreceptor 1Y on which the yellow toner image is formed continues to rotate at a predetermined speed to transport the toner image developed on the photoreceptor 1Y to a predetermined first transfer position.

After the yellow toner image on the photoreceptor 1Y is transported to the first transfer position, a first transfer bias is applied to the first transfer roller 5Y, and electrostatic force directed from the photoreceptor 1Y toward the first transfer roller 5Y acts on the toner image to transfer the toner image on the photoreceptor 1Y to the intermediate transfer belt 20. The transfer bias applied has the opposite polarity (positive) to the toner (negative), For example, the transfer bias for the first unit 10Y is controlled to +10 μA by the controller (not shown).

The toner remaining on the photoreceptor 1Y is removed and collected by the photoreceptor cleaning device 6Y.

The first transfer biases applied to the first transfer rollers 5M, 5C, and 5K of the second to fourth units 10M, 10C, and 10K are controlled in the same manner as in the first unit.

Thus, the intermediate transfer belt 20 to which the yellow toner image is transferred by the first unit 10Y is sequentially transported through the second to fourth units 10M, 10C, and 10K, and as a result, toner images of the respective colors are transferred in a superimposed manner.

The intermediate transfer belt 20, to which the toner images of the four colors are transferred in a superimposed manner through the first to fourth units, runs to a second transfer section including the intermediate transfer belt 20, the support roller 24 in contact with the inner surface of the intermediate transfer belt, and a second transfer roller 26 (an example of the second transfer unit) disposed on the image carrier side of the intermediate transfer belt 20. A recording paper P (an example of the recording medium) is fed into the nip between the second transfer roller 26 and the intermediate transfer belt 20 at a predetermined timing by a feed mechanism, and a second transfer bias is applied to the support roller 24. The transfer bias applied has the same polarity (negative) as the toner (negative), and electrostatic force directed from the intermediate transfer belt 20 toward the recording paper P acts on the toner image to transfer the toner image on the intermediate transfer belt 20 to the recording paper P. The second transfer bias is determined depending on the resistance detected by a resistance detector (not shown) that detects the resistance of the second transfer section, and thus the voltage is controlled.

The recording paper P is then sent to a pressure-contact part (nip part) between a pair of fixing rollers of a fixing device (an example of a fixing unit) 28, and the toner image is fixed to the recording paper P, thus forming a fixed image.

Examples of the recording paper P to which the toner image is transferred include plain paper for use in electrophotographic copiers, printers, and other devices. Examples of recording media other than the recording paper P include OHP sheets.

To further improve the surface smoothness of the fixed image, the surface of the recording paper P may also be smooth. For example, coated paper, i.e., plain paper coated with resin or the like and art paper for printing are suitable for use.

The recording paper P after completion of the fixing of the color image is conveyed to a discharge unit. Thus, the color image forming operation is complete.

### Process Cartridge and Toner Cartridge

A process cartridge according to an exemplary embodiment will be described.

The process cartridge according to the exemplary embodiment includes a developing unit that contains the electrostatic image developer according to the exemplary embodiment and that develops, with the electrostatic image developer, an electrostatic image formed on a surface of an image carrier to form a toner image. The process cartridge is attachable to and detachable from an image forming apparatus.

The process cartridge according to the exemplary embodiment may have other configurations. For example, the process cartridge according to The exemplary embodiment may include a developing device and optionally at least one selected from other units such as an image carrier, a charging unit, an electrostatic image forming unit, and a transfer unit.

A non-limiting example of the process cartridge according to the exemplary embodiment will now be described. The parts illustrated in the drawings are described, and the description of other parts is omitted.

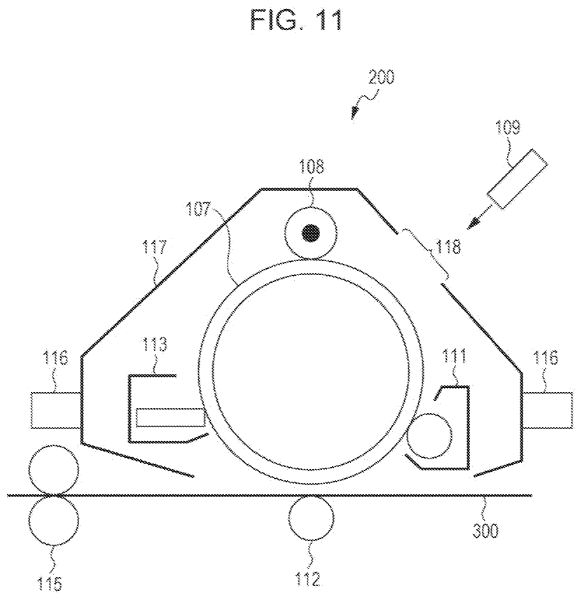

FIG. 11 illustrates a schematic configuration of the process cartridge according to the exemplary embodiment.

A process cartridge 200 illustrated in FIG. 11 includes, for example, a photoreceptor 107 (an example of the image carrier), a charging roller 108 (an example of the charging unit) disposed on the periphery of the photoreceptor 107, a developing device 111 (an example of the developing unit), and a photoreceptor cleaning device 113 (an example of the cleaning unit). These units are combined and held together into a cartridge with a housing 117 having mounting rails 116 and an opening 118 for exposure.

In FIG. 11, 109 represents an exposure device (an example of the electrostatic image forming unit), 112 represents a transfer device (an example of the transfer unit), 115 represents a fixing device (an example of the fixing unit), and 300 represents a recording paper (an example of the recording medium).

Next, a toner cartridge according to an exemplary embodiment will be described.

The toner cartridge according to the exemplary embodiment contains the toner according to the exemplary embodiment and is attachable to and detachable from an image forming apparatus. The toner cartridge contains replenishment toner to be supplied to a developing unit provided in the image forming apparatus.

The image forming apparatus illustrated in FIG. 10 is configured such that the toner cartridges 8Y, 8M, 8C, and 8K are attachable thereto and detachable therefrom. The developing devices 4Y, 4M, 4C, and 4K are connected to the toner cartridges corresponding to the developing devices (colors) through toner supply tubes (not shown). The toner cartridges are replaced when the amount of toner therein is decreased.

### EXAMPLES

The exemplary embodiments will now be described in detail with reference to Examples and Comparative Examples, but it should be noted that the exemplary embodiments are not limited to these Examples. “Parts” and “%” used to express amounts are by mass, unless otherwise specified.

### Synthesis of Polyester Resin 1

Into a reaction container equipped with a stirrer, a thermometer, a condenser, and a nitrogen gas inlet tube, 80 molar parts of polyoxypropylene (2,2)-2,2-bis(4-hydroxyphenyl)propane, 10 molar parts of ethylene glycol, 10 molar parts of cyclohexanediol, 80 molar parts of terephthalic acid, 10 molar parts of isophthalic acid, and 10 molar parts of n-dodecenylsuccinic acid are put, and the reaction container is purged with dry nitrogen gas. Thereafter, titanium tetrabutoxide serving as a catalyst is put into the reaction container in an amount of 0.25 parts by mass relative to 100 parts by mass of the monomer components. Under a stream of nitrogen gas, stirring is performed at 170° C. for 3 hours to cause a reaction, after which the temperature is further increased to 210° C. over one hour, and the pressure in the reaction container is reduced to 3 kPa. Under reduced pressure, the reaction is allowed to proceed with stirring for 13 hours to obtain a polyester resin 1. Using a differential scanning calorimeter (DSC), the glass transition temperature of the obtained resin is measured and found to be 56° C.

### Synthesis of Polyester Resin 2

A polyester resin 2 is synthesized in the same manner as in Synthesis of polyester resin 1 except that the amount of titanium tetrabutoxide serving as a catalyst is changed to 0.50 parts by mass relative so 100 parts by mass of the monomer components. Using a differential scanning calorimeter (DSC), the glass transition temperature of the obtained resin is measured and found to be 48° C.

### Preparation of Polyester Resin Particle Dispersion 1

Next, 200 parts by mass of the polyester resin 1, 100 parts by mass of methyl ethyl ketone, and 70 parts by mass of isopropyl alcohol are placed in a jacketed reaction vessel equipped with a condenser, a thermometer, a water dropper, and an anchor impeller. With the temperature being maintained at 70° C. by using a water-circulation-type constant temperature vessel, the resin is dissolved while mixing the components with stirring at 100 rpm. Thereafter, the number of stirring rotations is changed to 150 rpm, and the water-circulation-type constant temperature vessel is set to 66° C. After 10 parts of 10% aqueous ammonia (reagent) is put into the reaction vessel over 10 minutes, 600 parts by mass of ion-exchange water maintained at 66° C. is added dropwise into the reaction vessel at a rate of 5 parts by mass per minute to cause phase inversion, thereby obtaining an emulsified liquid. Six hundred parts of the emulsified liquid and 525 parts by mass of ion-exchange water are placed in a recovery flask, and the flask is mounted to an evaporator equipped with a vacuum-control unit with a trap ball interposed therebetween. The recovery flask is heated in a hot-water bath at 60° C. while being rotated, and the pressure is reduced to 7 kPa to remove the solvents while taking care not to cause bumping. When the amount of recovered solvent reaches 825 parts, the pressure is returned to normal pressure, and the recovery flask is cooled with water to obtain a dispersion. Ion-exchange water is added thereto to obtain a polyester resin particle dispersion 1 having a solids concentration of 20 mass %.

### Preparation of Polyester Resin Particle Dispersion 2

A polyester resin particle dispersion 2 is prepared in the same manner as the polyester resin particle dispersion 1 except that the polyester resin 1 is replaced with the polyester resin 2.

### Preparation of Release Agent Particle Dispersion 1

Paraffin wax (FNP92 manufactured by Nippon Seiro Co., Ltd., endothermic peak onset: 81° C.): 45 parts
Anionic surfactant (NEOGEN RK manufactured by DKS Co., Ltd.): 5 parts
Ion-exchange water: 200 parts

The above materials are mixed together, heated to 95° C., and dispersed using a homogenizer (ULTRA-TURRAX T50 manufactured by manufactured by IKA). Thereafter, a dispersion treatment is performed using a MANTON-GAULIN high-pressure homogenizer (Gaulin Corporation) to prepare a release agent particle dispersion 1 (solids concentration: 20%) in which a release agent is dispersed. The volume-average particle size of release agent particles is 0.19 μm.

### Preparation of Release Agent Particle Dispersion 2

Paraffin wax (HNP-9 manufactured by Nippon Seiro Co., Ltd., endothermic peak onset: 67° C.): 45 parts
Anionic surfactant (NEOGEN RK manufactured by DKS Co., Ltd.): 5 parts
Ion-exchange water: 200 parts

The above materials are mixed together, heated to 90° C., and dispersed using a homogenizer (ULTRA-TURRAX T50 manufactured by manufactured by IKA). Thereafter, a dispersion treatment is performed using a MANTON-GAULIN high-pressure homogenizer (Gaulin Corporation) to prepare a release agent particle dispersion 2 (solids concentration: 20%) in which a release agent is dispersed. The volume-average particle size of release agent particles is 0.23 μm.

### Preparation of Colorant Particle Dispersion

Cyan pigment (Pigment Blue 15:3 (copper phthalocyanine) manufactured by Dainichiseika Color & Chemicals Mfg. Co., Ltd.): 98 parts
Anionic surfactant (NEOGEN R manufactured by DKS Co., Ltd.): 2 parts
Ion-exchange water: 400 parts

The above materials are mixed and dissolved together, and dispersed using a homogenizer (IKA ULTRA-TURRAX) for 10 minutes to obtain a colorant particle dispersion having a median particle size of 0.16 μm and a solids content of 20%.

### Preparation of Carrier

In a pressure kneader, 100 parts of ferrite particles (manufactured by Powdertech Co., Ltd., average particle size: 50 μm), 1.5 parts of polymethyl methacrylate resin (manufactured by Mitsubishi Rayon Co., Ltd., weight-average molecular weight: 95,000, proportion of components having weight-average molecular weight of 10,000 or less: 5%), and 500 parts of toluene are placed and mixed with stirring at normal temperature for 15 minutes. The mixture is then heated to 70° C. while being mixed under reduced pressure to distill off toluene, and then cooled and classified using a 105 μm sieve to obtain a resin-coated ferrite carrier.

### Example 1

### Preparation of Toner

### Preparation of Toner Particles (1)

Polyester resin particle dispersion 1: 100 parts by mass
Colorant particle dispersion: 10 parts by mass
Release agent particle dispersion 1: 9 parts by mass
Anionic surfactant. (TAYCAPOWER BN2060 manufactured by TAYCA CORPORATION): 1 part by mass
Ion-exchange water: 200 parts by mass

The above raw materials are placed in a cylindrical stainless steel container, and. 3 parts of a 0.3 M (=0.3 mol/L) aqueous nitric acid solution is added thereto to adjust the pH to 3.0.

Subsequently, 50 parts of a 10% aqueous aluminum sulfate solution serving as an aggregating agent is added dropwise to the mixture while applying a shear force at 6,000 rpm using an ULTRATURRAX (manufactured by IKA), and stirring is performed for 5 minutes.

The above raw material mixture is then heated to 45° C. with a heating mantle and held there for 30 minutes, after which a coating resin particle dispersion prepared by adjusting the pH of a mixture of 25 parts of the polyester resin particle dispersion 1 and 10 parts of ion-exchange water to 3.0 in advance is added thereto for aggregated particle coating, and the resulting mixture is held for 10 minutes. Thereafter, to stop the growth of coated aggregated particles (adhered particles), the pH of the raw material mixture is controlled to 8.0 by adding a 1 M (=1 mol/L) aqueous sodium hydroxide solution. The temperature is then increased to 90° C. at a temperature increase rate of 1° C./min in order to fuse the aggregated particles. After 90° C. is reached, the temperature is held for 4 hours. Thereafter, the temperature is decreased to 40° C. to obtain a toner slurry A1. The toner particles dispersed in the aqueous solution are then filtered, washed with ion-exchange water, and then subjected to solid-liquid separation using Nutsche suction filtration. The solid is further redispersed in 3 L of ion-exchange water at 40° C., stirred at 300 rpm for 15 minutes, and washed. This operation is repeated five times, and then solid-liquid separation is performed by Nutsche suction filtration using No. 5A filter paper. The resulting solid is dried under vacuum over 12 hours to obtain toner particles 1 having a volume-average particle size of 6.1 μm.

### Preparation of Silica Particles (1)

SiCl₄, hydrogen gas, and oxygen gas are mixed together in a mixing chamber of a burner and then burnt at a temperature of 1,000° C. or higher and 3,000° C. or lower. A silica powder is collected from the burnt gas to obtain silica particles. At this time, the molar ratio of the hydrogen gas to the oxygen gas is set to 1.3:1, whereby silica particles (R1) having a volume-average particle size of 136 nm are obtained.

One hundred parts of the silica particles (R1) and 500 parts of ethanol are placed in an evaporator, and stirred for 15 minutes while maintaining the temperature at 40° C. Next, hexamethyldisilazane (HMDS) in an amount of 20 parts relative to 100 parts of the silica particles is added, and the resulting mixture is stirred for 15 minutes. Lastly, the temperature is increased to 90° C., and ethanol is dried under reduced pressure. The treated product is then taken out and further dried under vacuum at 120° C. for 30 minutes, thereby obtaining silica particles (1) treated with hexamethyldisilazane and having a volume-average particle size of 136 nm.

In the following step, a Henschel mixer FM75J/I manufactured by Mitsui Mining Co., Ltd. is used as an additive mixing device, and a blade (upper blade: second mixing blade) as illustrated as Z0 (upper) in FIG. 6 and a blade (lower blade: first mixing blade) as illustrated as B0 (lower) in FIG. 5 are used as mixing blades.

To 100 parts by mass of the toner particles 1, 5 parts of the silica particles (1) and 1.0 part of titanium oxide particles (average primary particle size: 15 nm, JAM-150IB manufactured by TAYCA CORPORATION) serving as external additives are added, and mixed together for 35 minutes such that the set internal temperature of the mixing device at which cooling is started using the Henschel mixer, the value of (Pm−P0)/w, and the value of (Pm−P0)·t/w are as shown in Table 1-1. For the internal temperature Ti of the mixing device, the initial temperature is 25° C., the highest temperature is 55° C., and the final temperature (Te) is 46° C., Thereafter, the second and subsequent mixing steps are continuously performed under the same conditions. The absolute values of differences between the first mixing step and the second and subsequent mixing steps (|Ten−Te1| and |Tan−Ta1|) are both 10° C. or less,

Next, screening is performed using an air screener (HI-BOLTER 300 manufactured by Shin Tokyo Kikai Co., Ltd.) to obtain a toner 1 (electrostatic image developing toner).

The free ratio of the additive particles in the toner 1 is then measured by the following method.

Into 50 mL of a 0.5% aqueous surfactant (NOIGEN ET-165 manufactured by DKS Co., Ltd.) solution to be measured, 4 g of the toner to be measured is added. The mixture is stirred with a magnetic stirrer at 100 rpm for 5 minutes to prepare a toner dispersion. Next, the toner dispersion is centrifuged at 3,000 rpm for 2 minutes, and the resulting supernatant fluid is removed. Thereafter, the settling toner is dispersed again by adding 50 mL of ion-exchange water, and the dispersion is suction filtered. (KIRIYAMA ROHTO filter paper No. 5C, 60 ϕ m/m, manufactured by Kiriyama Glass Works Co.). The residual toner on the filter paper is collected and dispersed by adding 50 mL of ion-exchange water, and suction filtration and washing are performed. After the washing, the residual toner on the filter paper is collected and dried in a 40° C. constant-temperature vessel for 12 hours. Using an automatic pressure forming machine (BRE-32 manufactured by MAEKAWA TESTING MACHINE MFG. Co., Ltd.), the resulting toner in an amount of 3 g is formed into a pellet (sample 1) having a diameter of 30 mm and a thickness of 2 mm under the following conditions: load, 10 t; pressing time, 60 s. Next, separately from this, the toner not subjected to the above treatment is formed into a pellet (sample 2) having a diameter of 30 mm and a thickness of 2 mm under the following conditions: load, 10 t; pressing time, 60 s. Furthermore, the toner particles before being mixed with the additive particles are also press formed (sample 0). Next, the quantitative analysis of constituent elements of the additive performed using an X-ray fluorescent analyzer (ZSX-100e manufactured by Rigaku Corporation). The metal element content of the samples is measured. Specifically, the metal element content of each sample is calculated using a calibration curve prepared in advance. Using these values, the free ratio is calculated by formula (A) below.

free ratio={(C2−C1)/(C1−C0)×100} Formula (A)

In formula (A), C0 represents the metal element content of sample 0, C1 represents the metal element content of sample 1, and C2 represents the metal element content of sample 2.

The strong adhesion ratio of the additive particles in the toner 1 is measured by the following method.

Into 50 mL of a 0.5% aqueous surfactant (NOIGEN ET-165 manufactured by DKS Co., Ltd.) solution to be measured, 4 g of the toner to be measured is added. The mixture is stirred with a magnetic stirrer at 100 rpm for 5 minutes to prepare a toner dispersion. Next, the toner dispersion is subjected to ultrasonic separation treatment. Ultrasonic waves are applied (height of ultrasonic vibration part from bottom, 1.0 cm; intensity, 40 W; 10 min) to the toner dispersion using an ultrasonic homogenizer (VCX750 manufactured by Sonic and Material. Inc.). Next, the toner dispersion is centrifuged at 3,000 rpm for 2 minutes, and the resulting supernatant fluid is removed. Thereafter, the settling toner is dispersed again by adding 50 mL of ion-exchange water, and the dispersion is suction filtered (KIRIYAMA ROHTO filter paper No. 5C, 60 ϕ m/m, manufactured by Kiriyama Glass Works Co.). The residual toner on the filter paper is collected and dispersed by adding 50 mL of ion-exchange water, and suction filtration and washing are performed. After the washing, the residual toner on the filter paper is collected and dried in a 40° C. constant-temperature vessel for 12 hours. Using an automatic pressure forming machine (BRE-32 manufactured by MAEKAWA TESTING MACHINE MFG, Co., Ltd.), the resulting toner in an amount of 3 g is formed into a pellet (sample 1) having a diameter of 30 mm and a thickness of 2 mm under the following conditions: load, 10 t; pressing time, 60 s. Next, separately from this, the toner not subjected to the above treatment is formed into a pellet (sample 2) having a diameter of 30 mm and a thickness of 2 mm under the following conditions: load, 10 t; pressing time, 60 s. Furthermore, the toner particles before being mixed with the additive particles are also press formed (sample 0). Next, the quantitative analysis of constituent elements of the additive is performed using an X-ray fluorescent analyzer (ZSX-100e manufactured by Rigaku Corporation). The metal element content of the samples is measured. Specifically, the metal element content of each sample is calculated using a calibration curve prepared in advance. Using these values, the strong adhesion ratio is calculated by formula (B) below.

strong adhesion ratio={(C1−C0)/(C2−C0)×100} Formula (B)

(Here, C0 represents the metal element content of sample 0, C1 represents the metal element content of sample 1, and C2 represents the metal element content of sample 2.)
Mixing of Toner with Carrier

The toner 1 and a carrier are placed in a V-blender in a ratio of toner:carrier=5:95 (mass ratio) and stirred for 20 minutes to obtain a developer 1 (electrostatic image developer).

### Examples 2 to 12 and Comparative Examples 1 to 3

A toner and a developer are each prepared in the same manner as in Example 1 except that the conditions in the mixing step are changed as shown in Tables 1-1 and 1-2 or Table 2.

### Example 13

Preparation of silica particles (2)

Silica particles (2) having a volume-average particle size of 82 nm are obtained under the same conditions and in the same manner as for the silica particles (1) except that the molar ratio of hydrogen gas to oxygen gas is 1.6:1.

A toner and a developer are each prepared in the same manner as in Example 1 except that the silica particles (2) are used as external additives in the mixing step in place of the silica particles (1). The conditions are shown in Table 2.

### Example 14

A toner and a developer are each prepared in the same manner as in Example 1 except that titanium oxide particles (average primary particle size: 40 nm, STT-30EHJ manufactured by Titan Kogyo, Ltd.) are used as external additives in the mixing step in place of the titanium oxide particles (average primary particle size: 15 nm, JAM-150IB manufactured by TAYCA CORPORATION).

### Example 15

### Preparation of Toner Particles (2)

Toner particles (2) are prepared in the same manner as the toner particles (1) except that the polyester resin particle dispersion 1 is replaced with the polyester resin particle dispersion 2. The volume-average particle size of the toner particles (2) is 6.2 wpm.

A toner and a developer are each prepared in the same manner as in Example 1 except that the toner particles 1 are replaced with the toner particles 2 in the mixing step.

### Example 16

A toner and a developer are each prepared in the same manner as in Example 1 except that a Loedige mixer (FKM50D manufactured by MATSUBO Corporation) is used as an additive mixing device in the mixing step in place of the Henschel mixer FM75J/I manufactured by Mitsui Mining Co., Ltd.

### Evaluations

Using the developers obtained, transferability and image unevenness suppressibility are evaluated.

### Transferability

Each developer is loaded into a modified machine of 700Digital Color Press manufactured by Fuji Xerox Co., Ltd. The developing potential is adjusted so that the toner mass per unit area on a photoreceptor will be 5 g/m², and in a low-temperature and low-humidity (temperature 10° C./relative humidity 20%) environment, an image with an area coverage of 5% is continuously output on 1,000 sheets of A4 plain paper. In outputting the next image, the evaluation machine is stopped immediately after a toner image on the photoreceptor has transferred to an intermediate transfer body (intermediate transfer belt) (i.e., before the photoreceptor is cleaned). The toner remaining on the photoreceptor without being transferred is collected with mending tape and weighed. From the toner mass per unit area at the time of development and the amount of remaining toner, initial transfer efficiency is determined by formula (A) below, and graded as described below. A and B are acceptable levels.

transfer efficiency=(toner mass per unit area at time of development−the amount of remaining toner)/toner mass per unit area at time of development×100 Formula (A)

### Evaluation Criteria

A: Transfer efficiency of 98% or more

B: Transfer efficiency of 95% or more and less than 98%

C: Transfer efficiency of 90% or more and less than 95%

D: Transfer efficiency of less than 90%

### Image Unevenness Suppressibility

Each developer is loaded into a developing device of an pimage forming apparatus “DocuCentre 500CP” manufactured by Xerox Co., Ltd. Using the image forming apparatus, a solid image with an image density of 90% partially including a non-image area is continuously output on 1,000 sheets of A4 paper in an environment at 10° C. and 15% RH, Subsequently, a halftone image with an image density of 50% is output on a sheet of A4 paper. For the output halftone image, areas corresponding to the non-image area and the solid image area of the solid image partially including a non-image area are measured for image density each at 12 points using an X-rite densitometer (X-rite 404 manufactured by X-rite Inc.), and their average values are calculated. The difference in image density between the area corresponding to the non-image area and the area corresponding to the solid image area is calculated, and image unevenness is evaluated. Evaluation criteria are as follows. A and B are acceptable levels.

Evaluation criteria

A: Image density difference of 0.2 or less

B: Image density difference of more than 0.2 and 0.3 or less

C: Image density difference of more than 0.3 and 0.4 or less

D: Image density difference of more than 0.4

The evaluation results are shown in Tables 1-1 and 1-2 and Table 2.

TABLE 1-1

| | | Internal | | | | | | | | |
|---|---|---|---|---|---|---|---|---|---|---|
| | Tg (° C.) of | temperature | | | | | | | | |
| | amorphous | Ti (° C.) of | | | | | | | | |
| | resin | mixing device | Set internal | | | | | | | |
| | contained | (initial | temperature | | | | | | | |
| | in near- | temperature → | (° C.) of | | | | | | | |
| | surface | highest | mixing device | Value of | Value of | | | | | |
| | portion | temperature → | at which | formula (2): | formula (3): | | \|Ten − | \|Tan − | Mixing | |
| | of toner | final | cooling | (Pm − | (Pm − | Te | Te1\| | Ta1\| | time | Mixing |
| | particles | temperature) | is started | P0)/w | P0) · t/w | (° C.) | (° C.) | (° C.) | (min) | device |
| Example 1 | 56 | 25→41→40 | 40 | 0.33 | 100 | 40 | 4 | 3 | 5 | Henschel mixer |
| Example 2 | 56 | 55→55→40 | 40 | 0.33 | 100 | 40 | 3 | 2 | 5 | Henschel mixer |
| Example 3 | 56 | 6→40→40 | 40 | 0.33 | 100 | 40 | 3 | 4 | 5 | Henschel mixer |
| Example 4 | 56 | 25→51→51 | 51 | 0.33 | 100 | 51 | 2 | 2 | 5 | Henschel mixer |
| Example 5 | 56 | 25→36→36 | 36 | 0.33 | 100 | 36 | 2 | 1 | 5 | Henschel mixer |
| Example 6 | 56 | 25→44→40 | 40 | 0.50 | 150 | 40 | 10 | 10 | 5 | Henschel mixer |
| Example 7 | 56 | 25→40→40 | 40 | 0.08 | 100 | 40 | 2 | 1 | 20 | Henschel mixer |
| Example 8 | 56 | 25→43→40 | 40 | 0.42 | 300 | 40 | 9 | 8 | 12 | Henschel mixer |
| Example 9 | 56 | 25→41→40 | 40 | 0.13 | 40 | 40 | 0 | 0 | 5 | Henschel mixer |
| Example 10 | 56 | 25→46→46 | 46 | 0.33 | 100 | 46 | 4 | 4 | 5 | Henschel mixer |

TABLE 1-2

| | Large-size additive particles | | | | Small-size additive particles | | | | | |
|---|---|---|---|---|---|---|---|---|---|---|
| | | Arithmetic | | | | Arithmetic | | | | |
| | | average | | Strong | | average | | Strong | | Image |
| | | particle | Free | adhesion | | particle | Free | adhesion | | unevenness |
| | | size | ratio | ratio | | size | ratio | ratio | Transfer- | suppress- |
| | Type | (nm) | (%) | (%) | Type | (nm) | (%) | (%) | ability | ibility |
| Example 1 | Silica particles (1) | 136 | 48 | 20 | JMT-150IB | 15 | 33 | 43 | A | A |
| Example 2 | Silica particles (1) | 136 | 25 | 30 | JMT-150IB | 15 | 23 | 70 | B | B |
| Example 3 | Silica particles (1) | 136 | 58 | 17 | JMT-150IB | 15 | 38 | 37 | A | B |
| Example 4 | Silica particles (1) | 136 | 22 | 30 | JMT-150IB | 15 | 17 | 78 | B | B |
| Example 5 | Silica particles (1) | 136 | 60 | 15 | JMT-150IB | 15 | 50 | 35 | A | B |
| Example 6 | Silica particles (1) | 136 | 28 | 28 | JMT-150IB | 15 | 17 | 80 | B | A |
| Example 7 | Silica particles (1) | 136 | 42 | 27 | JMT-150IB | 15 | 60 | 23 | A | B |
| Example 8 | Silica particles (1) | 136 | 31 | 29 | JMT-150IB | 15 | 14 | 79 | B | B |
| Example 9 | Silica particles (1) | 136 | 49 | 20 | JMT-150IB | 15 | 59 | 24 | A | B |
| Example 10 | Silica particles (1) | 136 | 26 | 29 | JMT-150IB | 15 | 18 | 70 | B | B |

TABLE 2

| | | Internal | | | | | | | | |
|---|---|---|---|---|---|---|---|---|---|---|
| | Tg (° C.) of | temperature | | | | | | | | |
| | amorphous | Ti (° C.) of | | | | | | | | |
| | resin | mixing device | Set internal | | | | | | | |
| | contained | (initial | temperature | | | | | | | |
| | in near- | temperature → | (° C.) of | | | | | | | |
| | surface | highest | mixing device | Value of | Value of | | | | | |
| | portion | temperature → | at which | formula (2): | formula (3): | | \|Ten − | \|Tan − | Mixing | |
| | of toner | final | cooling | (Pm − | (Pm − | Te | Te1\| | Ta1\| | time | Mixing |
| | particles | temperature) | is started | P0)/w | P0) · t/w | (° C.) | (° C.) | (° C.) | (min) | device |
| Example 11 | 56 | 25→47→40 | 40 | 0.48 | 290 | 40 | 12 | 12 | 10 | Henschel mixer |
| Example 12 | 56 | 25→40→40 | 40 | 0.10 | 200 | 48 | 1 | 0 | 35 | Henschel mixer |
| Example 13 | 56 | 25→40→40 | 40 | 0.33 | 100 | 40 | 2 | 1 | 5 | Henschel mixer |
| Example 14 | 56 | 25→40→40 | 40 | 0.33 | 100 | 43 | 2 | 2 | 5 | Henschel mixer |
| Example 15 | 48 | 25→38→38 | 38 | 0.33 | 100 | 38 | 1 | 1 | 5 | Henschel mixer |
| Example 16 | 56 | 25→40→40 | 40 | 0.33 | 100 | 40 | 2 | 3 | 5 | Loedige mixer |
| Comparative | 56 | 25→57→51 | 51 | 0.33 | 100 | 51 | 10 | 9 | 5 | Henschel mixer |
| Example 1 | | | | | | | | | | |
| Comparative | 56 | 25→45→40 | 40 | 0.58 | 350 | 40 | 10 | 9 | 10 | Henschel mixer |
| Example 2 | | | | | | | | | | |
| Comparative | 56 | 25→40→40 | 40 | 0.03 | 35 | 40 | 0 | 0 | 20 | Henschel mixer |
| Example 3 | | | | | | | | | | |

| | Large-size additive particles | | | | Small-size additive particles | | | | | |
|---|---|---|---|---|---|---|---|---|---|---|
| | | Arithmetic | | | | Arithmetic | | | | |
| | | average | | Strong | | average | | Strong | | Image |
| | | particle | Free | adhesion | | particle | Free | adhesion | | unevenness |
| | | size | ratio | ratio | | size | ratio | ratio | Transfer- | suppress- |
| | Type | (nm) | (%) | (%) | Type | (nm) | (%) | (%) | ability | ibility |
| Example 11 | Silica particles (1) | 136 | 27 | 27 | JMT-150IB | 15 | 16 | 78 | B | B |
| Example 12 | Silica particles (1) | 136 | 49 | 22 | JMT-150IB | 15 | 31 | 45 | B | A |
| Example 13 | Silica particles (2) | 82 | 46 | 21 | JMT-150IB | 15 | 32 | 42 | B | A |
| Example 14 | Silica particles (1) | 136 | 49 | 19 | STT-30EHJ | 40 | 50 | 38 | A | B |
| Example 15 | Silica particles (1) | 136 | 60 | 16 | JMT-150IB | 15 | 35 | 41 | B | A |
| Example 16 | Silica particles (1) | 136 | 52 | 25 | JMT-150IB | 15 | 31 | 45 | B | A |
| Comparative | Silica particles (1) | 136 | 20 | 41 | JMT-150IB | 15 | 20 | 70 | D | C |
| Example 1 | | | | | | | | | | |
| Comparative | Silica particles (1) | 136 | 26 | 31 | JMT-150IB | 15 | 12 | 86 | C | D |
| Example 2 | | | | | | | | | | |
| Comparative | Silica particles (1) | 136 | 48 | 19 | JMT-150IB | 15 | 62 | 22 | B | C |
| Example 3 | | | | | | | | | | |

The above results show that Examples, as compared to Comparative Examples, provide electrostatic image developing toners having high transferability and high image unevenness suppressibility.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A method for producing an electrostatic image developing toner, comprising:
mixing toner particles containing an amorphous resin with additive particles,
wherein a mixing device used in the mixing includes a stirring vessel, a stirring blade, and a jacket configured to cool the stirring vessel, and
condition (1) and condition (2) are satisfied:
condition (1): an internal temperature Ti of the mixing device in the mixing and a glass transition temperature Tg of the amorphous resin contained in a near-surface portion of the toner particles satisfy Tg−50° C.≤Ti<Tg (inequality 1), and
condition (2): 0.08≤(Pm−P0)/w≤0.50 (inequality 2) is satisfied,
where, in inequality 2, Pm represents an average power (kW) of a motor for driving the stirring blade of the mixing device in the mixing, P0 represents an idling power (kW) of the motor, and w represents a total mass (kg) of the toner particles and the additive particles in the mixing device.

2. A method for producing an electrostatic image developing toner, comprising:
mixing toner particles containing an amorphous resin with additive particles,
wherein a mixing device used in the mixing includes a stirring vessel, a stirring blade, and a jacket configured to cool the stirring vessel, and
condition (1) and condition (3) are satisfied:
condition (1): an internal temperature Ti of the mixing device in the mixing and a glass transition temperature Tg of the amorphous resin contained in a near-surface portion of the toner particles satisfy Tg−50° C.≤Ti<Tg (inequality 1), and
condition (3): 40≤(Pm−P0)·t/w≤300 (inequality 3) is satisfied,
where, in inequality 3, t represents a mixing time (s) in the mixing, Pm represents an average power (kW) of a motor for driving the stirring blade of the mixing device in the mixing, P0 represents an idling power (kW) of the motor, and w represents a total mass (kg) of the toner particles and the additive particles in the mixing device.

3. The method for producing an electrostatic image developing toner according to claim 1, wherein a set internal temperature of the mixing device in the mixing at which cooling is started by passing water through the jacket is “the glass transition temperature Tg of the amorphous resin−30° C.” or higher and “the glass transition temperature Tg of the amorphous resin−5° C.” or lower.

4. The method for producing an electrostatic image developing toner according to claim 2, wherein set internal temperature of the mixing device in the mixing at which cooling is started by passing water through the jacket is “the glass transition temperature Tg of the amorphous resin−30° C.” or higher and “the glass transition temperature Tg of the amorphous resin−5° C.” or lower.

5. The method for producing an electrostatic image developing toner according to claim 1, wherein a rotation speed of the stirring blade in the mixing is 20 m/s or more and 80 m/s or less.

6. The method for producing an electrostatic image developing toner according to claim 2, wherein a rotation speed of the stirring blade in the mixing is 20 m/s or more and 80 m/s or less.

7. The method for producing an electrostatic image developing toner according to claim 3, wherein a rotation speed of the stirring blade in the mixing is 20 m/s or more and 80 m/s or less.

8. The method for producing an electrostatic image developing toner according to claim 4, wherein a rotation speed of the stirring In the mixing 20 m/s or more and 80 m/s or less.

9. The method for producing an electrostatic image developing toner according to claim 1, wherein an internal temperature Te of the device at completion of the mixing is “the glass transition temperature Tg of the amorphous resin−25° C.” or higher and “the glass transition temperature Tg of the amorphous resin−10° C.” or lower.

10. The method for producing an electrostatic image developing toner according to claim 2, wherein an internal temperature Te of the device at completion of the mixing is “the glass transition temperature Tg of the amorphous resin−25° C.” or higher and “the glass transition temperature Tg of the amorphous resin−10° C.” or lower.

11. The method for producing an electrostatic image developing toner according to claim 3, wherein an internal temperature Te of the device at completion of the mixing is “the glass transition temperature Tg of the amorphous resin−25° C.” or higher and “the glass transition temperature Tg of the amorphous resin−10° C.” or lower.

12. The method for producing an electrostatic image developing toner according to claim 4, wherein an internal temperature Te of the device at completion of the mixing is “the glass transition temperature Tg of the amorphous resin−25° C.” or higher and “the glass transition temperature Tg of the amorphous resin−10° C.” or lower.

13. The method for producing ac electrostatic image developing toner according to claim 1, wherein the additive particles include one or more types of large-size additive particles having an arithmetic average particle size of 60 nm or more and two or more types of small-size additive particles having an arithmetic average particle size of less than 60 nm.

14. The method for producing an electrostatic image developing toner according to claim 13, wherein the one or more types of large-size additive particles have an arithmetic average particle size of 100 nm or more.

15. The method for producing an electrostatic image developing toner according to claim 13, wherein in a toner obtained by the mixing, the additive particles have a free ratio of 60% or less, the free ratio representing a percentage of additive particles not adhering to the toner particles, the one or more types of large-size additive particles have a strong adhesion ratio of 30% or less, and the two or more types of small-size additive particles have a strong adhesion ratio of 80% or less, the strong adhesion ratios each representing a percentage of additive particles adhering to the toner that has been subjected to ultrasonic separation treatment.

16. The method for producing an electrostatic image developing toner according to claim 1, wherein the additive particles include inorganic oxide particles.

17. The method for producing an electrostatic image developing toner according to claim 16, wherein the inorganic oxide particles include large-size inorganic oxide particles having an arithmetic average particle size of 60 nm or more and small-size inorganic oxide particles having an arithmetic average particle size of less than 60 nm.

18. The method for producing an electrostatic image developing toner according to claim 1, wherein the mixing is performed for 5 minutes or more and 30 minutes or less.

19. The method for producing an electrostatic image developing toner according to claim 1, wherein when Te is an internal temperature of the device at completion of the mixing, and Ta is an average temperature in the device during a time period from two minutes after start of the mixing until completion of the mixing, |Ten−Te1|≤10° C. and |Tan−Ta1|≤10° C. are always satisfied, where Te1 and Ta1 are Te and Ta, respectively, of first mixing in a case where the mixing is continuously performed twice or more, Ten and Tan are Te and Ta, respectively, of nth mixing, and |Ten−Te1| and |Tan−Ta1| represent absolute values of Ten−Te1 and Tan−Ta1, respectively.

20. An electrostatic image developing toner produced by the method for producing the electrostatic image developing toner according to claim 1.
